(19) United States
(12) Patent Application Publication
(10) Pub. No.: US 2006/0269649 A1
(43) Pub. Date: Nov. 30, 2006

(54) Modular mold change system

(76) Inventor: Vince Ciccone, Kleinberg (CA)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 10/549,773

(22) PCT Filed: Mar. 18, 2004
(86) PCT No.: PCT/CA04/00403

§ 371 Date: Jul. 12, 2006

Related U.S. Application Data
(60) Provisional application No. 60/455,397, filed on Mar. 18, 2003.

(51) Int. Cl. B23P 19/00

(52) U.S. Cl. 425/556; 29/426.1

(57) ABSTRACT

A method of removing components of an injection mold machine having a core assembly and a cavity assembly, the method including the steps of: (a) moving the core assembly and the cavity assembly into a closed position whereat a cavity insert and a core insert are mated together; (b) securing a core plate to a cavity plate, thereby forming a mold module; (c) releasing a securing means which secures the cavity plate to a manifold plate; (d) opening the mold from the closed position, until a first cavity plate disengages the manifold plate and all connections thereto, (e) releasing a securing means which secures the core plate to a master core plate; and (f) lifting the mold module in a direction perpendicular to a direction of motion between the open and closed position, the module being guided in the perpendicular direction by the guide means.

### FIELD OF THE INVENTION

This invention relates to injection molding machines and in particular to a system for changing components of the mold machine.

### BACKGROUND OF THE INVENTION

It is known to provide systems which attempt to achieve the quick and efficient changing of mold machine components. A typical mold change system involves the removal of the complete mold (or mold set) including core plates, manifold plate, cavity plate and attached inserts from the injection mold machine in a manner which requires the disconnecting of water hoses, airlines, and electrical connectors necessary for proper operation of the machine. In such prior art systems, before disconnecting all these services, the mold must be drained of water and the hot-runner switched off. The mold is typically then unclamped and hoisted out of the molding machine, typically with an overhead crane. When installing a new mold in the injection machine, in a known manner all the above-mentioned services must be reconnected. The process of reconnection is quite time consuming. Furthermore, such reconnection is often uncleanly due to necessity of disconnecting water hoses. Safety is also a concern during reconnection as mold technicians often must climb on top of the mold to access the water and electrical connections. Furthermore since all services are disconnected and reconnected, water drained, valuable time is lost waiting for the mold and machine to heat up again once the mold is installed. It should be mentioned that when changing molds in such a manner, the hoses typically have to be fully removed as different molds have different sizes and quantities of connectors.

Furthermore, known support mechanisms which secure the molds within the machine platen of the mold machine, are not typically adaptable to accommodate mold or machines of different sizes and/or require hand loading of heavy parts once the mold is moved in between the machine platens. The molds or mold sets which may be removed from the mold machine may be referred to herein as an MMC.

### SUMMARY OF THE INVENTION

It is an object of the invention to provide an improved method and apparatus which allows for removal and installation of mold components in a quick and efficient manner.

It is a further object of the invention to provide an improved method and apparatus for removing the entire “mold set” or “mold” comprising the master core plates, core plates, cavity plates manifold plates and all connections therebetween (also referred to as an MMC) from the mold machine.

In accordance with an aspect of the invention there is provided a method of removing components of a mold set from the injection mold machine, said mold set comprising the following components: a core assembly including a master core plate, a core plate releasably secured to said master core plate, said master core plate including guide means for guiding said core plate relative to said master core plate; a core insert secured to said core plate; a cavity assembly comprising a manifold plate, a first cavity plate releasably secured to the manifold plate, said first cavity plate oriented in the opposing direction to the core plate, a cavity insert attached to the cavity plate, said cavity assembly moveable relative to the core assembly such that the cavity insert and core insert may be selectively mated together to define a cavity therebetween into which molten plastic may be injected from a molten plastic source, said cavity forming a shape of a desired article, said method comprising the steps of:
(a) moving the core assembly and cavity assembly into a closed position whereat the cavity insert and core insert are mated together;
(b) securing said core plate to said cavity plate, thereby forming a mold module;
(c) releasing the securing means which secures the cavity plate to the manifold plate;
(d) opening the mold from the closed position, until the first cavity plate disengages the manifold plate and all connections thereto,
(e) releasing the securing means which secures the core plate to the master core plate;
(f) lifting said mold module in a direction perpendicular to the direction of motion between said open and closed position, said module being guided in in said perpendicular direction by said guide means.

Hoisting means may be attached to the mold module, prior to step (e) above. Steps (c) and (e) might have to be undertaken with the mold in the open position in some circumstances.

In accordance with a further aspect of the invention, there is provided a method of removing components of a stack injection mold machine, said machine comprising: a stationary core assembly and an opposing facing moving core assembly each core assembly including a master core plate, and a core plate releasably secured to the master core plate, a first core insert secured to said core plate, an intermediate cavity assembly comprising central manifold plates, a pair of cavity plates releasably secured on either side of said manifold plates, each cavity plate having a cavity insert, said cavity assembly and moving core assembly movable by moving mold press means in such a manner that the core inserts and cavity inserts are separated by equal amounts on either side of the cavity assembly, and may be mated together simultaneously, the cavity and core inserts defining a cavity therebetween each, into which molten plastic may be injected from a molten plastic source, said cavities forming the shape of a desired article, the method comprising the following steps:
(a) moving the core assemblies and cavity assembly into a closed position whereat the mating cavity inserts and core inserts are mated together;
(b) securing the core plates to their respective mating cavity plates to form respective mold modules comprised of core plates, core inserts, cavity inserts and cavity plates;
(c) releasing the securing means which secures the cavity plates to the manifold plate;
(d) moving the moving core assembly and cavity assembly from the closed position to an open position until said cavity plates are separated from said manifold plate and all connections thereto;
(e) releasing said securing means which secures said core plates to said respective master core plates;
(f) hoisting said first and second mold modules simultaneously outwardly in a direction perpedicular to the direction of motion between said open and closed position, said modules being guided in said perpendicular direction by guiding means which guides said core plates perpendicularly along said master core plates.
   Hoisting means may be attached prior to step (e) above.
   In accordance with yet a further aspect of the invention there is provided a hoist bar, comprising a main bar having an upper side and a lower side, and a pair of blocks secured to the lower side of said bar at opposite ends thereof, each block having an opening parallel to the length of the bar, said bar having at least one hoist member secured to the upper side of the bar, said hoist bar adapted for lifting said bar, a guide pin extending through the opening in each said block, said guide pins having mounting blocks at the end of each guide pin, which limit the sliding movement of the guide pins within each opening, each said mounting block being adapted to mount a mold plate, thereby when said mounting blocks are mounted to said plates, said plates may slide relative to the main bar, and said hoist bar may be lifted when said mounted mold plates have slid into a selectable relative sliding position on the lift bar.
   In accordance with yet another aspect of the invention there is provided an apparatus for supporting mold plates within a mold machine, said apparatus comprising: a mold support member, said support member being positionable in an operable position whereat said support member interconnects said plate to a tie bar or guide way of the mold machine, allowing riding of said plate on said tie bar or guide way and positionable in an inoperable position.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### DESCRIPTION OF THE DRAWINGS

FIG. 1 is a cross section view taken along a vertical plane through the mold center with the mold in an open position of a stack mold embodiment of the invention, illustrating the moving side of the machine on the left, and the stationary side on the right;

FIG. 2 is a cross section view along the vertical plane of the mold of FIG. 1, through the mold center with the mold in a closed position;

FIG. 3 is a cross section view along the vertical plane through the mold center of a stack mold embodiment of the invention with mold in an open position and a mold module disengaged from the manifold plate and exposed components thereof such as hot runner nozzle tips in accordance with the invention;

FIG. 4 is a cross section view along the vertical plane through the mold center of a stack mold of FIG. 1 with mold open and mold modules disengaged from manifold plate and secured to hoist bar, being hoisted out of the injection machine in accordance with the invention;

FIG. 5 is a plan view of core side of the mold machine taken along arrow X-X in FIGS. 2 and 3;

FIG. 6 is a plan view of cavity side of the mold machine taken along arrow Y-Y in FIGS. 2 and 3;

FIG. 7 is a plan view of the X side of the mold (stationary core side), showing a mold support mechanism which allows removal of mold sets (MMC) from the mold machine;

FIG. 8 is a simplified view corresponding to that of FIG. 7, showing the mold set positioned within the injection mold machine, showing the components of the mold support mechanism to the sides, ready for installation;

FIG. 9 is a plan partial section view of the X side of the mold (stationary core side), showing an alternate embodiment of a mold support mechanism, for use with the tie bars of the injection machine, showing this embodiment in an operating position on the right hand side, and in a storage position on the left hand side;

FIG. 9A is an enlarged plan view of the mold support mechanism of FIG. 9 shown in operating position;

FIG. 9B is an end view of the embodiment of the mold support system shown in FIG. 9 in an operating position;

FIG. 9C is an enlarged plan view of the mold support mechanism of FIG. 9 shown in a storage position;

FIG. 9D is an end view of the embodiment of the mold support system of FIG. 9 shown in a storage position;

FIG. 10 is a plan partial section view of the X side of the mold (stationary core side), showing an alternate embodiment of the mold support mechanism, for use with the guide ways of the injection machine, showing this embodiment in an operating position on the right hand side of FIG. 10, and a storage position on the left hand side of FIG. 10;

FIG. 10A is an enlarged view of the mold support mechanism of FIG. 10, shown in the operating position;

FIG. 10B is an end view of the mold support mechanism of FIG. 10A in the operating position;

FIG. 10C is an enlarged view of the mold support mechanism of FIG. 10, shown in storage position;

FIG. 10D is an enlarged end view of the mold support mechanism of FIG. 10C in a storage position;

FIG. 11 is a plan partial section view of the X side of the mold (stationary core side), showing another alternate embodiment of the mold support mechanism, for use with the tie bars of the injection machine, showing the mechanism in operating position on the right hand side of FIG. 11, and in storage position on the left hand side of FIG. 11;

FIG. 12 is a plan view of the X side of the mold (stationary core side), showing yet another alternate embodiment of the mold support mechanism, for use with the tie bars of the injection machine shown in the operating position on the right hand side of FIG. 12 and in the storage position mechanism on the left hand side of FIG. 12;

FIG. 12A is an enlarged view of the mold support mechanism of FIG. 12 shown in operating position;

FIG. 12B is an end view of the mold support mechanism of FIG. 12 in the operating position;

FIG. 12C is an enlarged view of the mold support mechanism of FIG. 12, shown in storage position;

FIG. 12D is an end view of the mold support mechanism of FIG. 12C shown in a storage position;

FIG. 12E is a plan partial section view of the X side of the mold (stationary core side), showing the swinging motion of the mold support mechanism of FIG. 12, from storage position (under the mold plate) to operating position (on top of the tie bars), as it takes place while the MMC is lowered into the machine;

FIG. 13 is a plan partial section view of the X side of the mold (stationary core side), showing an embodiment of a system designed to grip and tighten the mold module onto the modular mold change system, showing the mechanism in operating position (tightened) on the right hand side of FIG. 13, and in storage position (released) on the left hand side of FIG. 13;

FIG. 14 is a vertical side section view of an embodiment of a stack mold having reversed gating, which uses activating cylinders to control the motion of the ejection system, shown with mold closed in a closed position with activation cylinders attached to manifold plates;

FIG. 14A is a view corresponding to that of FIG. 14 of the stack mold of FIG. 14, shown with the mold in the open position.

FIG. 14B is a plan view of the Y side (core side) of the stack mold of FIG. 14;

FIG. 14C is a side view of the stack mold of FIG. 14B, shown with the mold open, and the mold modules being lifted out of the MMC.

FIG. 15 is a side view of an embodiment of a stack mold having reversed gating, which uses activating cylinders to control the motion of the ejection system, shown with the mold in a closed position, the activating cylinders of this embodiment being secured onto core plates of mold modules;

FIG. 15A is a side view of the stack mold of FIG. 15 shown with the mold open;

FIG. 15B is a plan view of the Y side (core side) of the stack mold of FIG. 15;

FIG. 15C is a side view of the stack mold of FIG. 15, shown with the mold open, and the mold modules being lifted out of the MMC.

FIGS. 16A to 16B shows further embodiments of couplings that could replace the quick disconnect couplings used for water and air services throughout the MMC, shown in FIG. 16A at the interface with the mold modules.

Similar reference numerals are used in different figures to denote similar components.

### DETAILED DESCRIPTION OF EXAMPLE EMBODIMENTS

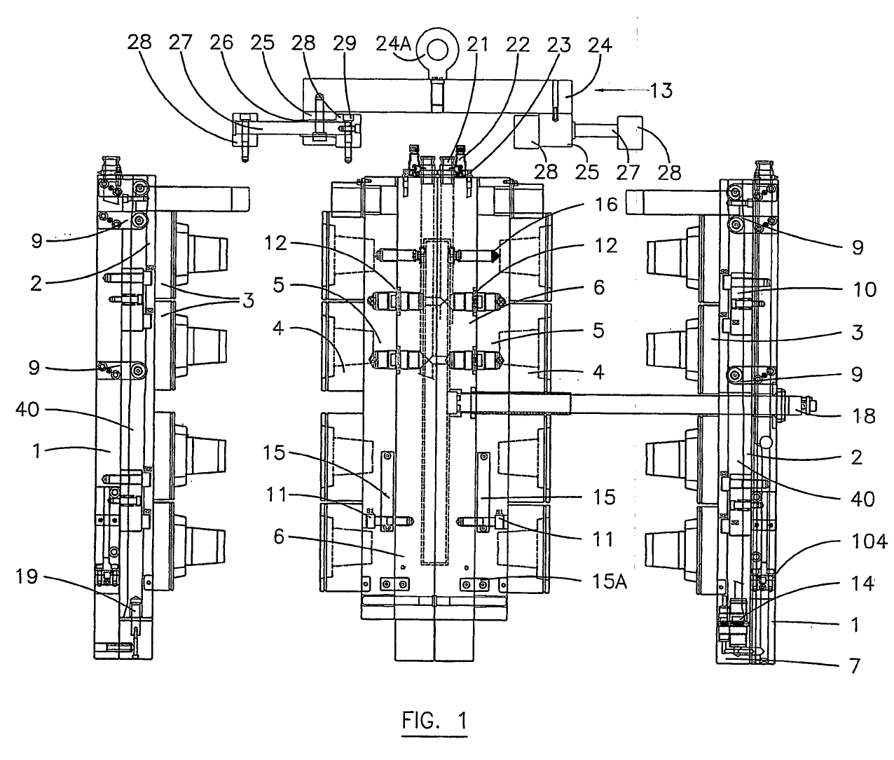

An example embodiment of an aspect of the invention will now be described, by way of example, with reference to the accompanying drawings, particularly FIGS. 1 to 6. The drawings show an embodiment of the mold change system (also referred to as an MMC) in accordance with the invention, used with a stack mold having a 2×8 (16 cavity) arrangement, used for molding thin walled containers designed for consumer use. It should be understood that the system may be utilized with a single face mold system and may be used to form any shape or type of article.

The following is a detailed description of how an embodiment of an MMC system allows the quick change over of mold products (i.e. cavity and core plates with attached inserts) with all service (water, air and heats) left intact, while the mold plates are changed. This MMC system may be utilized with single face and stack molds systems.

As shown in FIGS. 1 to 6, the mold or mold set (also referred to as an MMC) in the mold machine consists of a master core plate 1 secured to the mold machine platen, core plate 2, core insert 3, cavity insert 4, cavity plate 5, manifold plate 6, water manifold 7, mold support 104, roller guide bar 9, clamp bar 10, quick disconnect couplings 12 (male and female), safety straps 15 and 15A. It should be understood that the above mentioned components are repeated twice on a stack mold both stationary side shown on the right side of FIGS. 1 to 6 and moving side shown in the left side of FIGS. 1 to 6 and some of the non-related components that may be shown on the design will not be discussed since they are common on any style of mold. Also each mold module 500 when formed in the manner discussed below for removal, will be considered as all components between and including plates 2 and 5, therefor including cavity inserts 4 and core inserts 3. Further components will be discussed below as necessary.

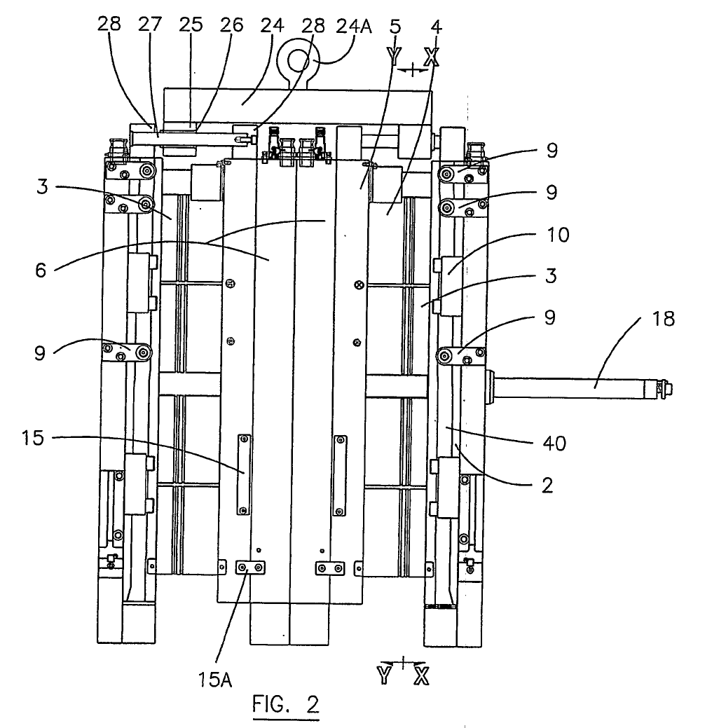

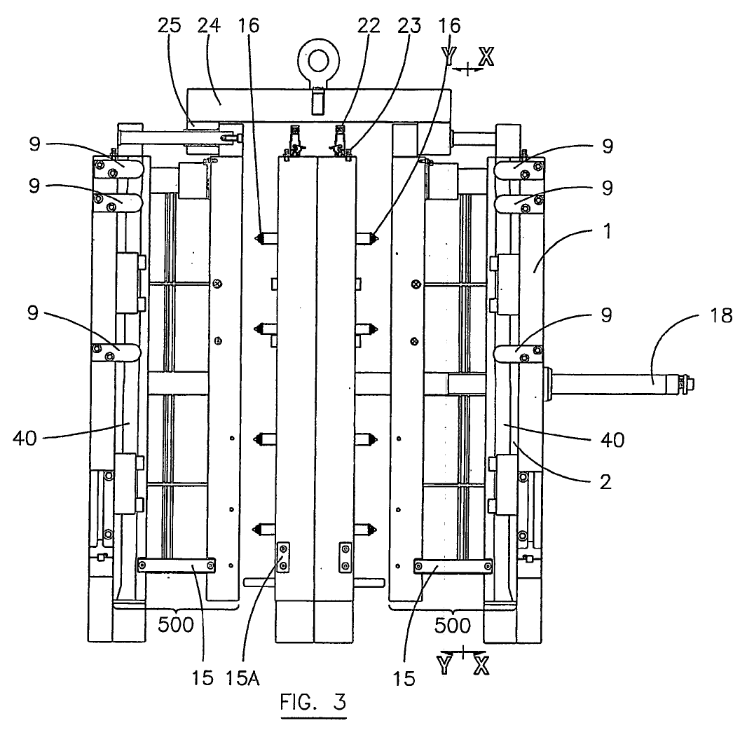

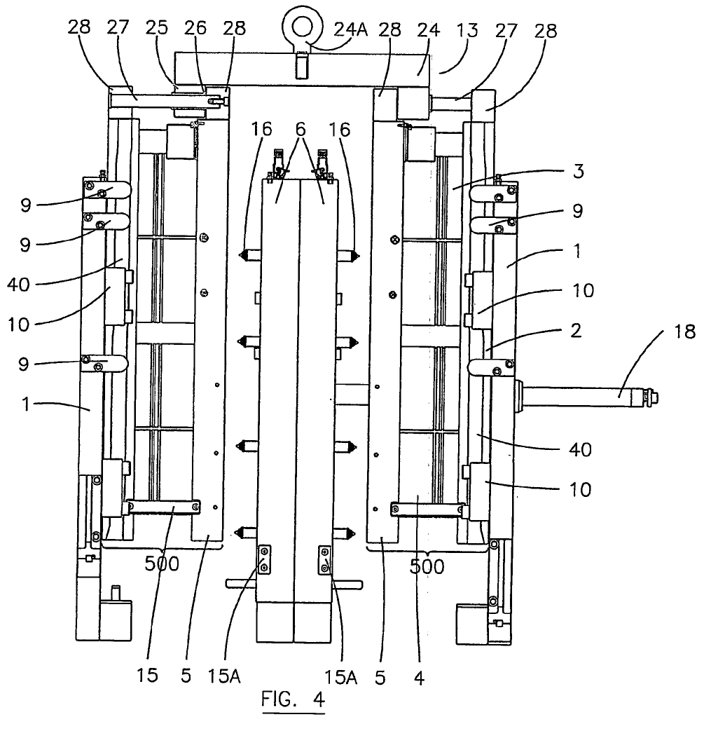

A stack injection mold machine includes the following mold components, a stationary core assembly, shown on the right side of FIG. 1, and an opposing facing moving core assembly, shown on the left side of FIG. 1, each core assembly including a master core plate 1, and a core plate 2 releasably secured to the master core plate by clamp means 10. Each master core plate 1 includes guide means 9, such as for example guide rollers 9 which engage the core plate, for guiding said core plate relative to said master core plate when said module is hoisted out of the machine. The core plate 2 has a core insert 3 secured thereto. Also included is an intermediate cavity assembly comprising central manifold plates 6, a pair of cavity plates 5 releasably secured on either side of said manifold plates 6, each cavity plate having a cavity insert 4, said cavity assembly and moving core assembly movable by moving mold press means in such a manner that the core inserts and cavity inserts are separated by equal amounts on either side of the cavity assembly, and the core and cavity inserts on either side of the manifold plate may be mated together simultaneously, the cavity and core inserts defining a cavity therebetween each, into which molten plastic may be injected from a molten plastic source, preferably from sprue bar 18 and via hot runner system through nozzle tips 16, said cavities forming the shape of a desired article. A preferred method of removal of particular mold product components in a stack mold system in accordance with an aspect of this invention is as follows:
(a) moving the core assemblies and cavity assemblies into a closed position whereat the mating cavity inserts and core inserts are mated together;
(b) securing the core plates to their respective mating cavity plates to form respective mold modules 500 comprised of core plates, core inserts, cavity inserts and cavity plates;
(c) releasing the securing means which secures the cavity plates to the manifold plate;
(d) moving the moving core assembly and cavity assembly from the closed position to an open position until said cavity plates are separated from said manifold plate and all connections thereto;
(e) releasing said securing means which secures said core plates to said respective master core plates;
(f) hoisting said first and second mold modules simultaneously outwardly in a direction perpendicular to the direction of motion between said open and closed position, said modules being guided in said perpendicular direction by said guiding means which guides said core plates perpendicularly along said master core plates and out of contact therewith.
   To better understand the mold module 500 removal process, a particular example of a mold module removal procedure with a stack mold will now be discussed.
   1. The mold shown in FIG. 1 is in the open position.
   2. Remove the securing means securing the cavity plate to the manifold plate, such as a bolt or the like. Optionally a temporary securing means such as for example, peripheral straps 15A may be placed between manifold plate and cavity plate, such as plates 5 and 6, then securing means between these plates such as screws 11 are removed.
   3. The mold is moved to a closed position as shown in FIG. 2.
   4. Securing means such as safety strap 15 is installed between plates 2 and 5 (as can be seen in FIG. 3, preferably at four places and safety straps 15A (if installed) are removed, straps 15 creating a mold module comprising plates 2 and 5 and respective inserts.
   5. In the case of stack molds, adjustable lift bar assembly 13 may be installed at the top of plates 2 and 5 on sliding mounting blocks 28 as will be discussed further below.
   6. For a stack mold machine, the mold machine is opened slowly until the limit of stroke limiter on lifting bar stops the machine as can be seen in FIG. 3. Operation of the adjustable lift bar assembly will be described further below.
   7. Screws are released on clamp bar 10 which secures the core plate to the master core plate, preferably at four places on moving side and 4 places on stationary side.
   8. A hoist is attached on lift bar 13.
   9. The complete mold module is lifted out of the injection machine as shown in FIG. 4, with the mold module 500 guided by roller guides 9, which guide the plate along a contoured slot 40 on plate 2. The purpose of this slot is to guide the mold module out of the machine without damaging the hot runner tips and to guide the release of the “quick disconnect couplings” 14 that transfer water and air from plate 1 to 7 and into 2. It should be understood that the hot runner assembly 6 stays in the machine supported by a mold carrier device for stack molds or it will stay fixed to the stationary platen of the machine if it is a single face mold (not shown). Also the master core plate 1 stays fixed to both machine platens (on the moving and stationary sides) for a stack mold or to the moving platen if it is a single face mold.
It should be understood that this module removal may be undertaken for single face molds as well, and if such is the case, the hoist bar is not necessary for hoisting the module out of the machine and the procedure would be as follows: (a) moving the core assembly and cavity assembly into a closed position, whereat the cavity insert and core insert are mated together;
(b) securing said core plate to said cavity plate, thereby forming a mold module;
(c) releasing the securing means which secures the cavity plate to the manifold plate;
(d) opening the mold from the closed position, until the first cavity plate disengages the manifold plate and all connections thereto,
(e) releasing the securing means which secures the core plate to the master core plate;
(f) lifting said mold module in a direction perpendicular to the direction of motion between said open and closed position, said module being guided in in said perpendicular direction by said guide means. The guide means preferably comprises guide rollers, which engage the core plate and guide the module out of engagement with the master core plate, in a direction perpendicular to the direction of movement of opening and closing the mold machine.

Hoist means may be attached to the module prior to step (e) above.

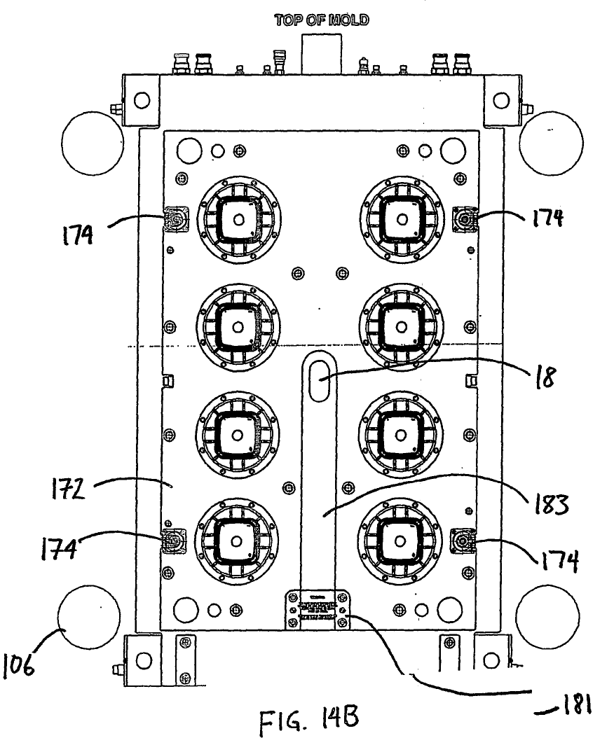

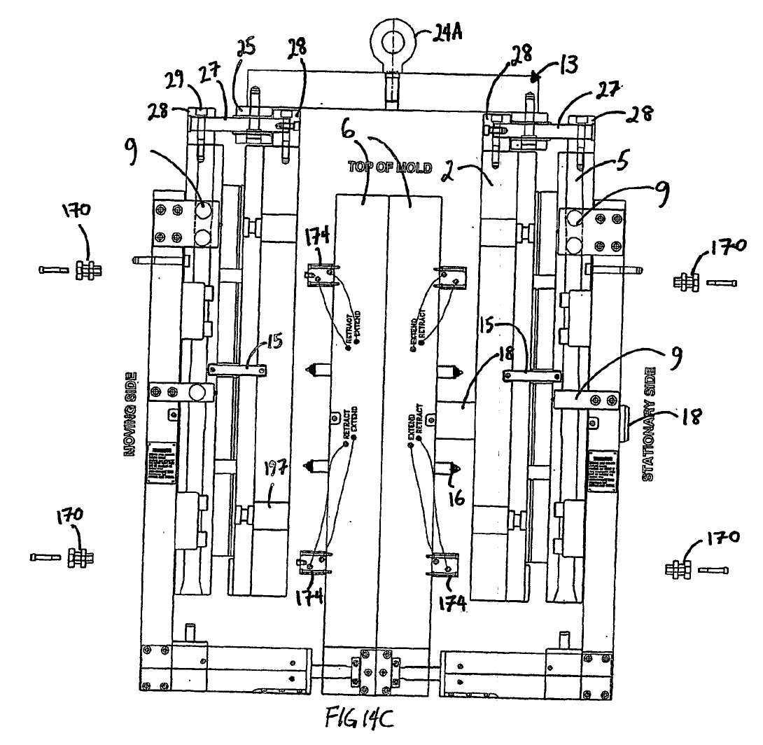

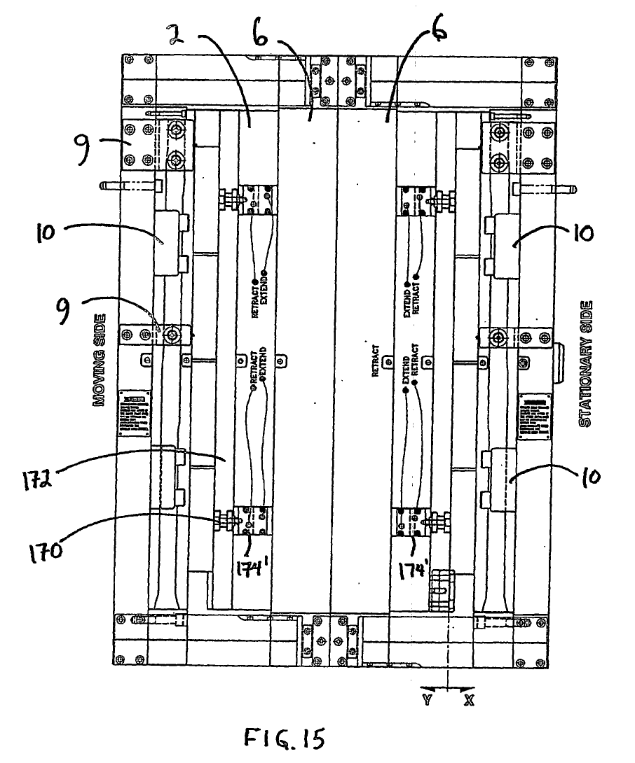

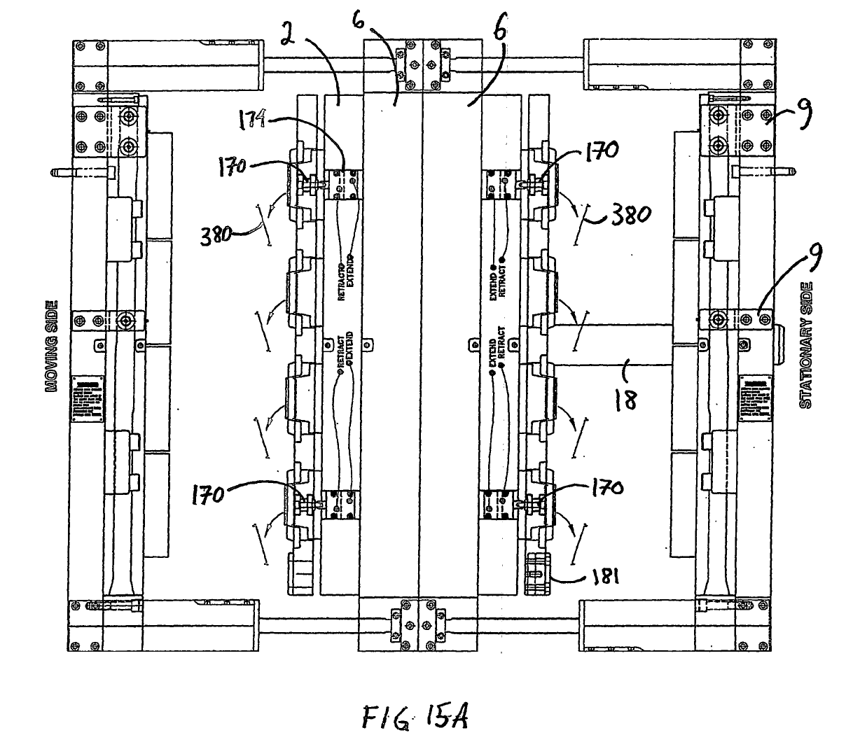

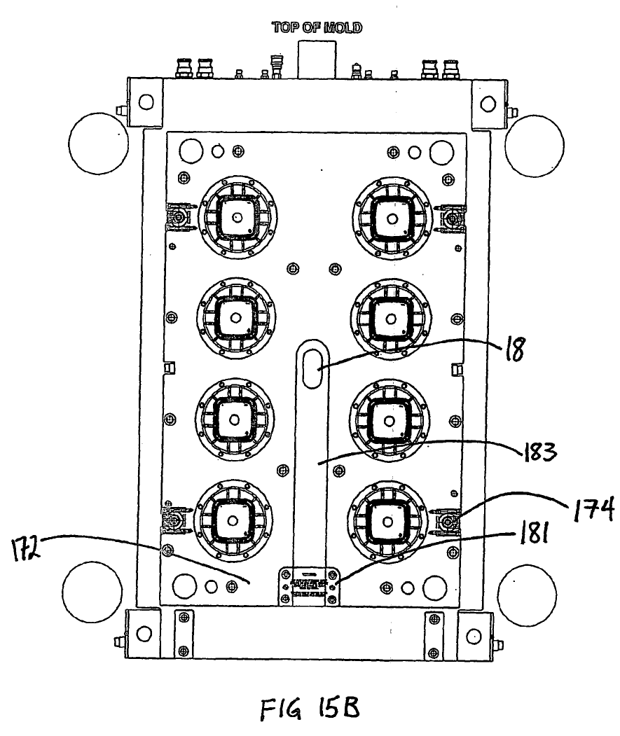

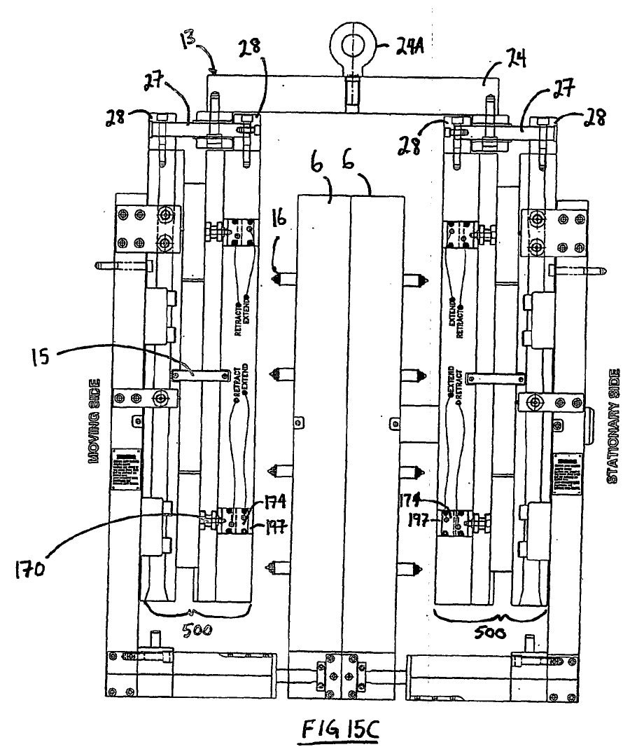

It should be further understood that core plate 2 and cavity plate 5 may be in opposite positions, with the core plates positioned centrally and cavity plates 5 positioned on the ends of the mold machine, secured to said master core plates 1 and core plates 2, adjacent central manifold plates 6. An example of such orientation is shown in FIGS. 14 to 15C.

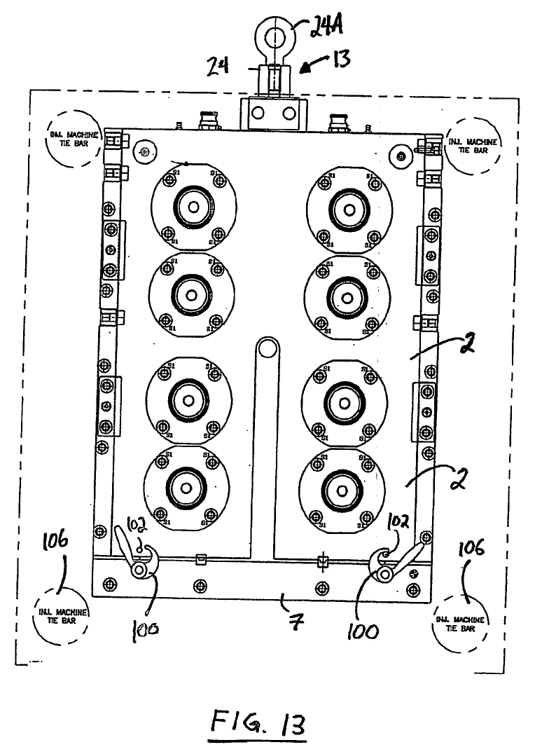

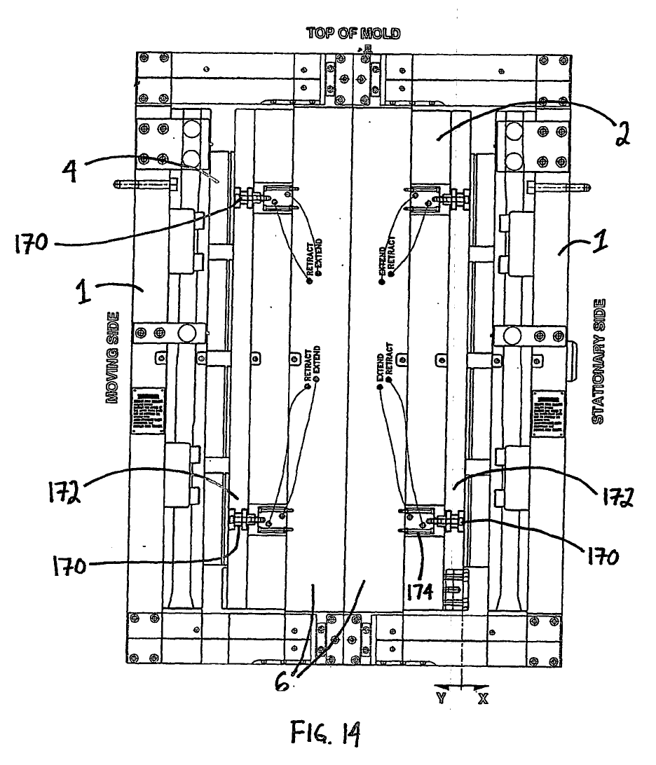

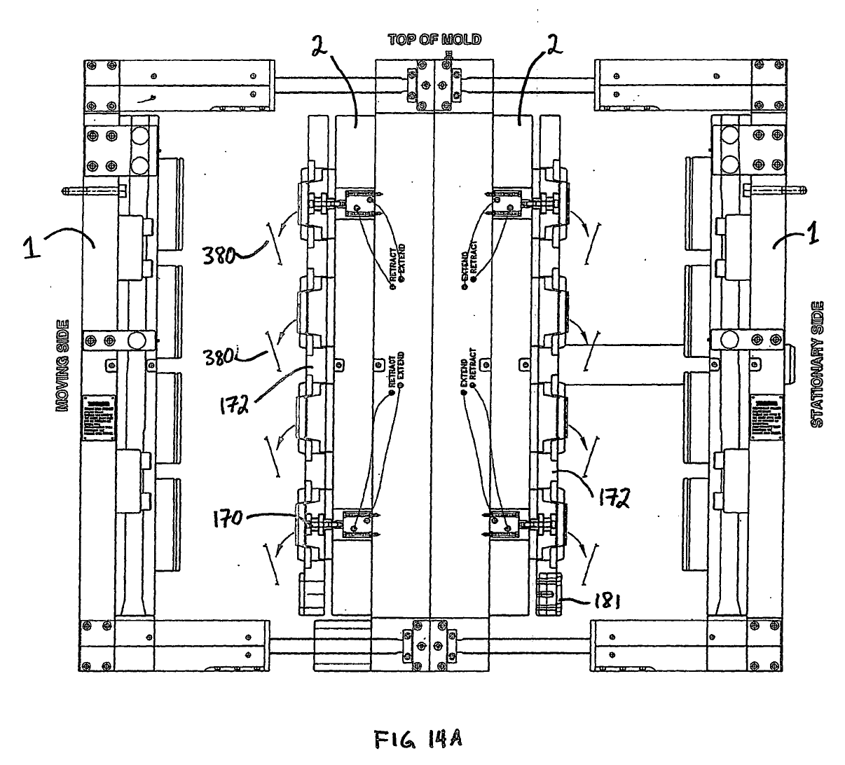

A new mold module, comprising replacement cavity and core plates with respective inserts, would be installed repeating these steps in the reverse sequence. Upon installation, as will be discussed below, water and air services will be connected by quick disconnect couplings, and final alignment will be aided by a tightening system as discussed below and shown in FIG. 13.

The following further describes the features of the invention with reference to the drawings: In the embodiment shown in FIGS. 1 to 6, cavity cooling is transferred to the cavity plate 5 via quick disconnect couplings 12. The male and female couplings 12 may be purchased from manufacturers of water fittings and are designed to automatically shut off the flow of water once cavity plate 5 is moved away from the manifold plate 6. This allows the manifold plate 6 to remain in the machine with water pressure on and electrical service connected.

As best seen in FIG. 1, the in/out conduits for water 21, air 23 and electrical connectors 22 are typically designed to be connected on the top periphery of the mold but may be connected on the bottom of the machine. Cavity inserts 4 are designed to be mounted to the cavity plate 5, with the cavity plate carrying water and air to all the individual cavities. Cavity plate 5 holds all the cavity inserts securely during the molding operation and while the cavity plate is disengaged from the manifold plate, being secured to the core plate and removed during mold change operation as described herein. The electrical connectors 22 are for the purpose to supply power to the hot runner system. The nozzle tips 16 that are part of the hot runner system are heated via nozzle coil heaters, which engage the cavity inserts 4 and remain constant from one mold module to another.

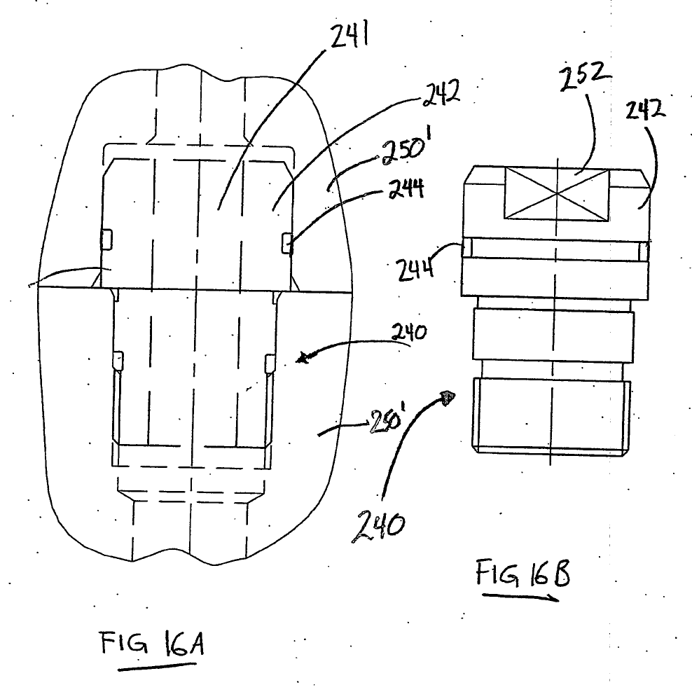

With reference to the embodiments set out herein, the quick disconnect couplings used to transfer water and air from the Modular Mold Change System to mold modules could be replaced by fittings that are more economical such as are shown in FIGS. 16A, 16B shows an example of such a design: the fitting 240 has a conduit defined therethrough aligning with the conduit extending between MMC components 250 and mold plates 250′, and may be installed in threaded engagement and centered in the MMC component 250 (manifold plate or water manifold), and has an extension 242, complete with a sealing element 244, for engagement in a releasably attached plate 250′ (such as cavity plate or core plate). The sealing element is positioned on the extension in a manner that the sealing element will not fall off when the extension is disengaged from the component 250. The fitting may have at least one flat surface 252 which may be used to tighten the fitting into the opening in component 250 in threaded engagement therewith. It should be understood that various designs of such economical fittings could be used with the MMC, without departing from the scope of this invention, provided that the couplings automatically shut off the flow of water once for example upon removal of the mold module, cavity plate 5 is moved away from the manifold plate 6. This allows the manifold plate 6 to remain in the machine with water pressure on and electrical service connected.

The master core plate 1 serves many purposes such as, securely holding the core plate 2 during molding as well as guiding the core plate during modular mold changes along contoured slot 40, and provides cooling to the core plate 2. The master core plate 1 is fastened to the machine platen and is not removed during mold change over. As shown in the Figures, the cooling In/Outs conduits and air conduits are typically designed to be connected on top of the mold but may be connected on the bottom in other embodiments of mold machines.

During change of the mold module, roller guide bars 9 are affixed to the master core plate and serve the purpose of guiding the mold module in and out of the mold in the direction perpendicular to the opening and closing of the mold machine. In a preferred embodiment of mold machine, contoured slot 40 on the core plate 2 is designed to allow the core plate 2 to move perpendicular to the motion of opening and closing the mold machine, preferably vertically and parallel to the master core plate 1 for a short distance while the quick disconnect couplings disengage and then moves the core plate 2 slightly away from the master core plate 1 so that the plate may be then rapidly hoisted out of the mold base without picking up friction from core plate to master core plate. This is best illustrated in FIG. 4. It should be understood that although the slot is described with a specific shape, it may in fact be any suitable shape, such as a straight oriented slot.

It should be understood that core plate 2 has a guide slot designed for the purpose as noted above but the slot also serves a second function that is to provide a seating ledge for clamp bar 10. When the modular mold assembly has to be removed, the clamp bars are unscrewed just enough to allow the slot to freely pass by the clamp bars. This may be achieved by placing a pre-loaded spring under the clamp bar so as to provide lift to the clamp bar while unscrewing the fasteners. The main purpose of the clamp bars is to provide quick and easy access to unlocking the core plate 2 from the master core plate and as many as four to six clamp bars may be required per master core plate.

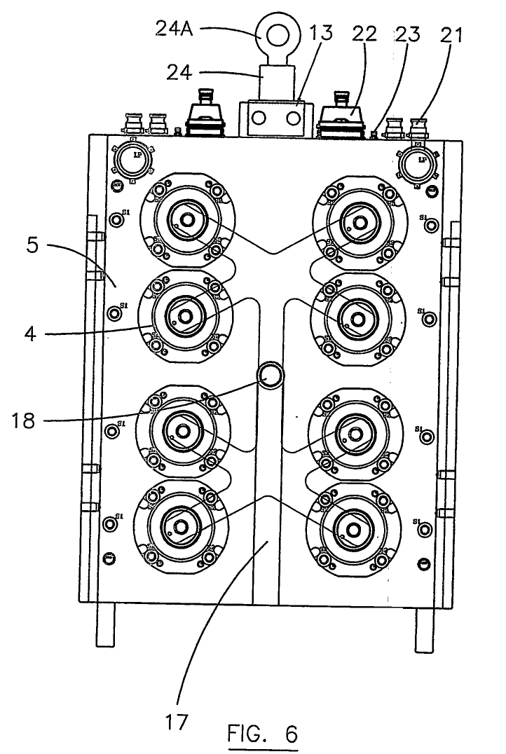

In the embodiment of FIGS. 1 to 6, the core plate 2 also requires a slot 17 to provide clearance to the sprue bar 18 when removing and installing the mold modules, as shown in FIG. 6. Present in stack mold machines, the sprue bar 18 transfers plastic from the injection machine nozzle to the center of the mold. The slot 17 allows clearance for the sprue bar upon removal of the mold module. The slot would not be required on a single face mold. A similar slot is also required on cavity plate 5, which faces stationary core plate 2.

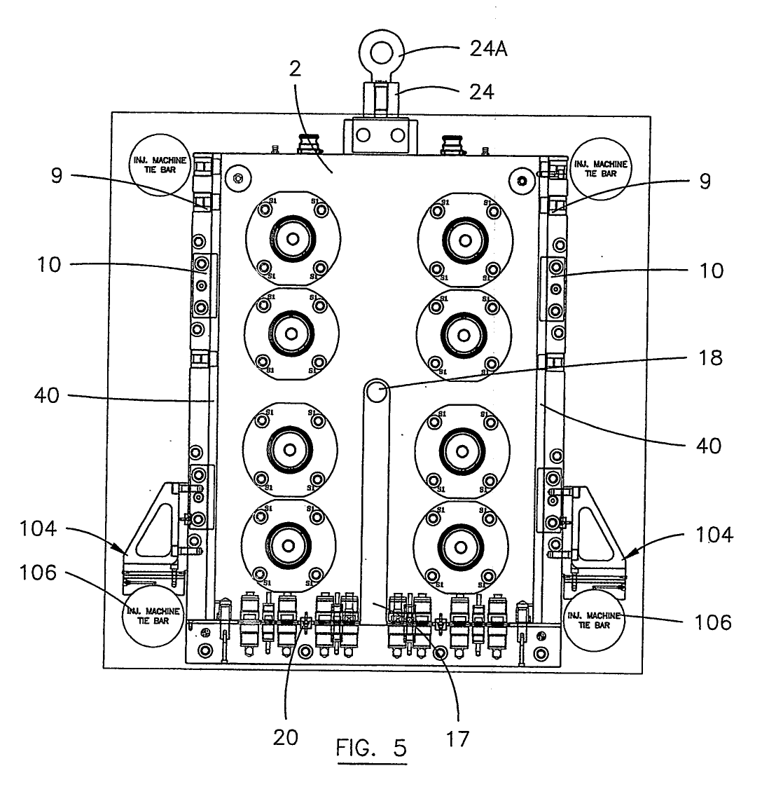

In the embodiment of FIGS. 1 to 6, water manifold 7 is permanently fastened to the master core plate 1 and provides the transfer of water from the master core plate to core plate 2. The male and female quick disconnect couplings 14 are placed in the water manifold and respectively on the core plate 2. The water manifold has two guide pins 19 that precisely guide the core plate to the water manifold to protect the quick disconnect couplings from normal wear and tear. It should be noted that the guide slot 40 on core plate 2 will only guide the plate loosely without great precision and for this reason the guide pins 19 are required. The water manifold also has two key blocks 20 (male and female, straight or tapered as shown) fastened to it and respectively the opposite side fastened to the core plate 2 as shown in FIG. 5. The purpose of the key block is to accurately center the core plate 2 both horizontally and vertically to the master core plate 1. The second function of the key blocks is to provide structural support to the slotted core plate 2 as the plate has become considerably weakened due to the sprue bar clearance. Further more by using key blocks and not conical locks the core plate 2 may be re-clamped to master core plate 1 while allowing the plate to freely move in an horizontal direction perpendicular to the master core plate.

Hoist attachment means such as the Adjustable Lift (or hoist bar) 13 lifts the mold modules on both the stationary and moving sides out of the mold base simultaneously. Lifting both sides out simultaneously saves injection machine down time and allows both modules to be transported around and stored together. The adjustable lift bar 13 as described in detail below, allows the mold modules in a stack mold (on both sides of the intermediate manifold plate) to be moved out of engagement from manifold plate and the components thereof such as the hot runner nozzle tips 16 and therefor allow the modules to be simultaneously hoisted out of the machine. Lift bar may also be designed for reverse gated systems such as shown in FIGS. 14 to 15 which require clearance of further components prior to removal of the modules.

With reference to FIGS. 1 to 6, the lift bar assembly 13 is designed with one main bar 24 (referred to as a lift or hoist bar), which has blocks 25 with two guide bushings 26 fastened to it at both end and one eyebolt 24A at the center. Two eyebolts 24A positioned at opposite ends of the lift bar may be utilized to improve the stability of the bar during lifting. The guide bushings have guide pins 27 running through which are fixed firmly to mounting blocks 28. The mounting blocks 28 are the part of the lift bar assembly, which attaches to the mold modules by fastening means 29. Mounting blocks fixed at both ends of guide pins which are slidably engaged through blocks 25, which is fixed firmly to bar 24, see FIG. 4. The sliding engagement of the mounting blocks allows the mold machine to be opened with mold modules attached to the mounting blocks 28, thereby allowing cavity plate to disengage the manifold plate and all components while being engaged to the mounting blocks. This would not be possible if the lift bar was based on a static design. Once the lift bar 13 is fastened to the mold module by means of mounting blocks, the mold machine can be opened slowly (manual mode) until block 25 hits block 28 as shown in FIG. 3. The sliding capability of the lift bar assembly allows for the machine operator to open the stack tool to a pre-determined setting programmed by the lift bar allowing clearance of the cavity plate from the manifold plate and all components thereof. This unique feature allows for different mold module heights to be loaded in and out of the machine at the same pre-determined setting. It follows that each mold module may have a dedicated Adjustable Lift Bar Assembly sized to accommodate the removal of plates. Cost may be a factor since various lift bars for each sized machine may be required, however the benefits may out weight the minimal cost of producing extra lift bars since each module may be safely stored with its own dedicated lift bar assembly and can easily be loaded into the injection machine since the previous module has set the mold opening height.

With respect to stack mold systems, in order to ensure that mold modules do not move relative to each other when they clear the cam rollers, once the mold modules are clear of the roller guides, they may be strapped to each other across the bottom portions thereof, to ensure that they are secure for storage thereof with hoist bar.

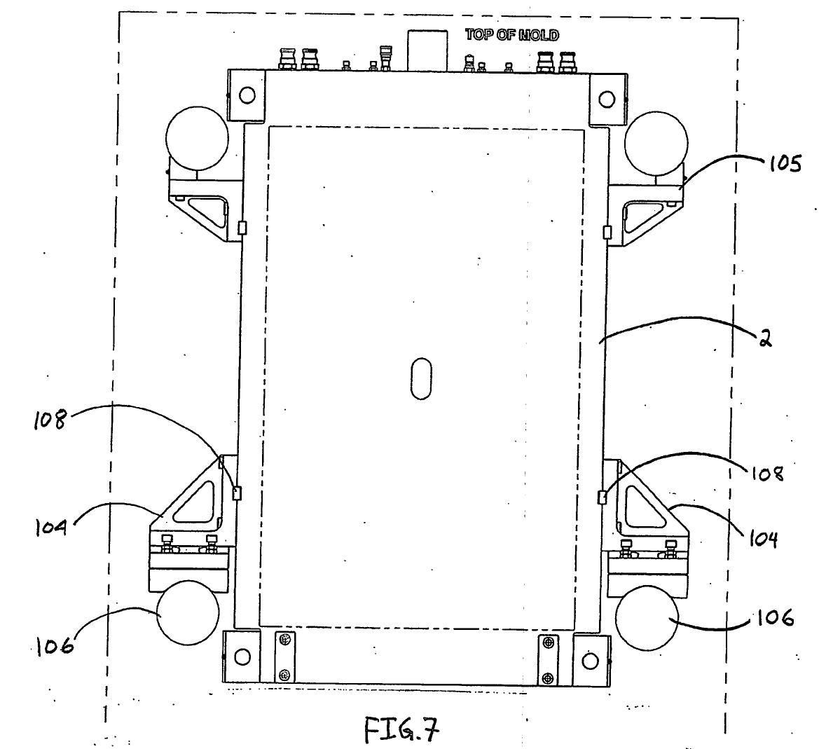

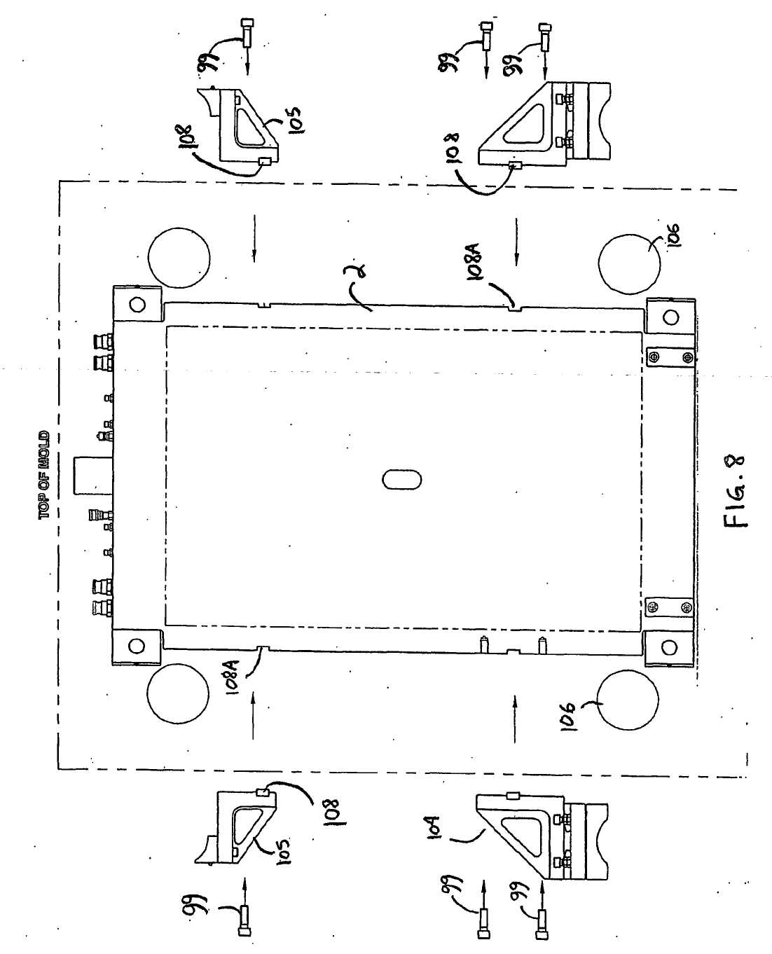

A further aspect of this invention relates to a mold support mechanism which supports the mold system (also referred to as “MMC”) on the injection mold machine, designed for use with the tie bars 106 of the injection machine or guides 126. As shown in FIGS. 7 and 8, the mold system, comprising the mold plates such as plate 2 shown in the Figures, and attachments thereto, is held by the bottom mold supports 104, which are clamped by clamp screws 99 onto the sides of the mold plates, and located with transversal keys 108. The bottom mold supports 104 ride onto the lower tie bars 106 of the injection machine. The top mold supports 105, also clamped onto the sides of the mold plates and located with transversal keys 108 in mating slot 108A, guide the motion of the mold plates by riding on the top tie bars 106 of the injection machine.

The support system shown in FIGS. 7 and 8 is inflexible in that it is designed specifically for a particular mold and an injection machine layout, and cannot accommodate any other injection machine than the one they were designed for. In accordance with an aspect of this invention, there is provided a mold support system having some degree of flexibility regarding the choice of injection machine or size of mold. The following designs are examples of mold support mechanisms having adaptability to mold size and shape variations.

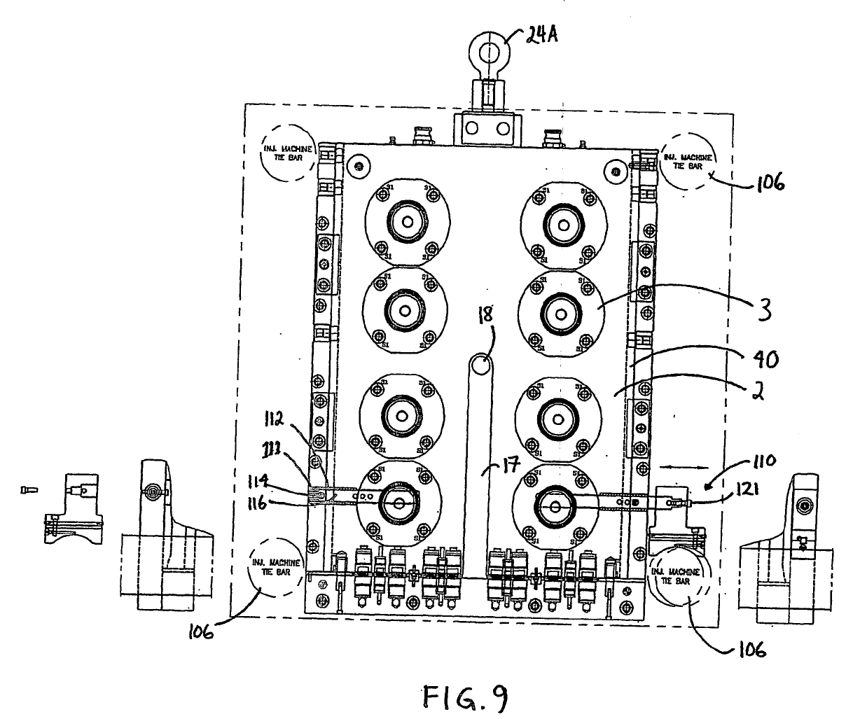

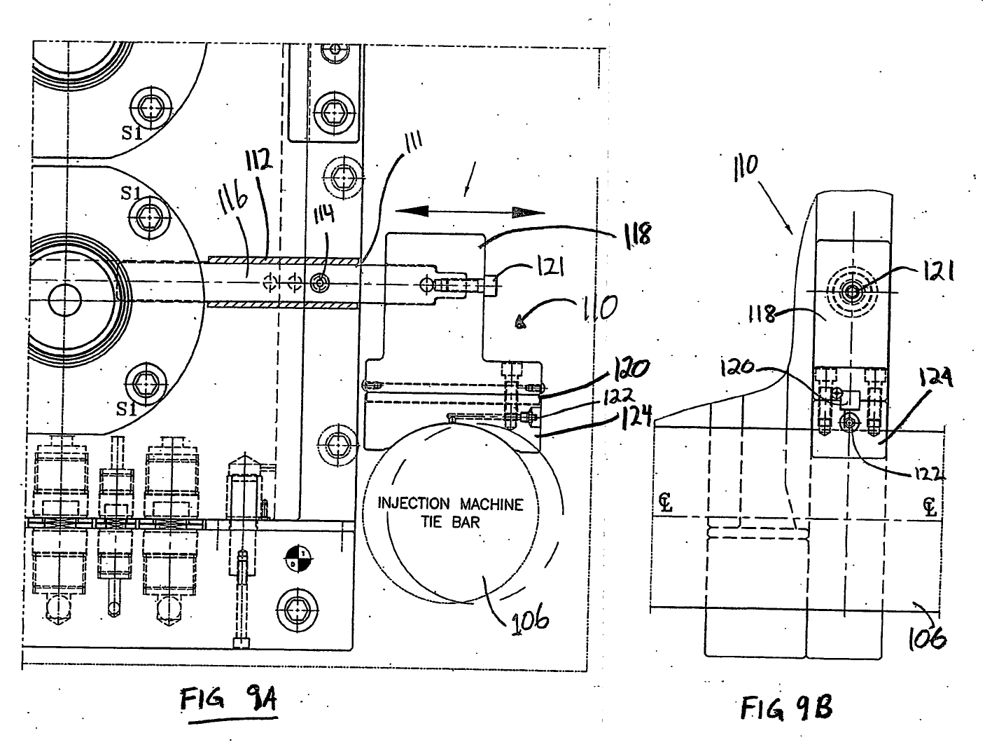

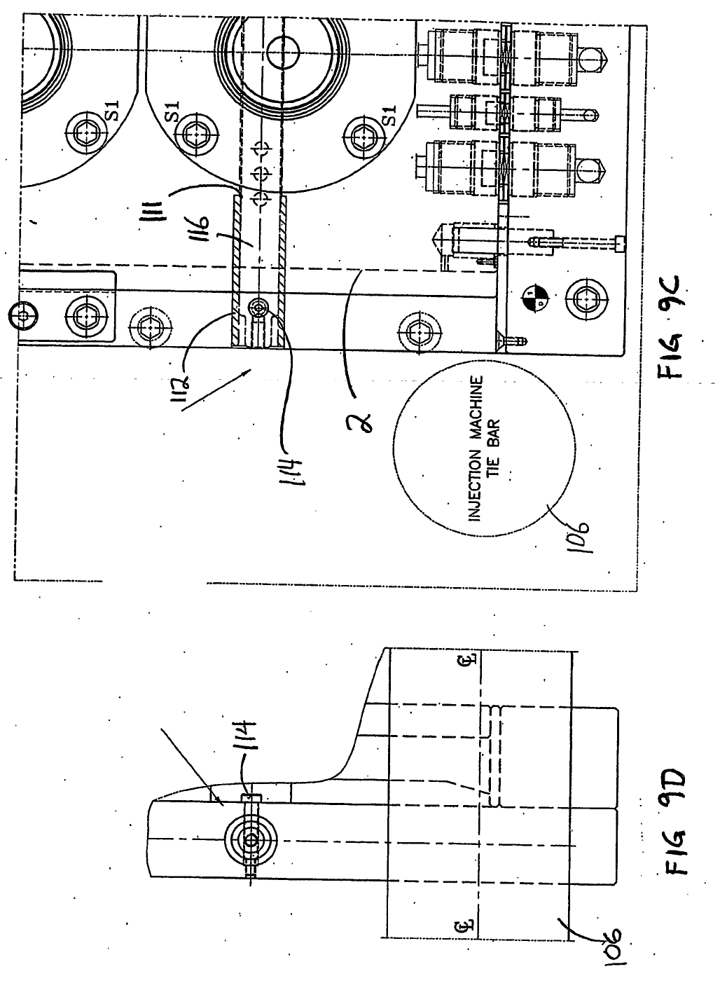

FIGS. 9, 9A, 9B and 9C and 9D show an example embodiment of an alternate mold support mechanism 110 attached to mold plates on the X side. In this embodiment, mold plates, such as plate 2 shown in the Figures, are provided with pockets 111 shaped to accept support pins 116, which work in two generic positions: an extended position shown in FIG. 9A, where they stick out towards the tie bars 106 of the injection machine, and a retracted position (shown in FIG. 9C), where they are located in the pockets 111 of the mold plates, below the surface of these plates. The support pins 116 are guided by bushings 112, which are held in fixed position in mold plates. A stopper 114 is used to secure each support pin in one of the two generic positions, and to prevent it from disengaging from the mold plate. When support pins 116 are extended, after being secured in operating position by stoppers 114, the mold support mechanisms can be secured with fasteners 121 to the exposed end of the support pins 116. The mold support mechanism 110 consists of three main parts: a bracket 118, a support pad 124 and a locating key 120. The bracket 118 is the part that is secured to the support pin. Below the support pin portion, the bracket 118 is fastened to the support pad 124, which has a surface shaped to rest onto the tie bars 106 of the injection machine. The support pad is located in reference to the bracket by way of the locating key 120, which is housed in matching slots machined on the contact surfaces of the bracket and support pad. The support pad is made of a material with low coefficient of friction, in order to avoid scoring the tie bars of the injection machine. Lubrication between support pad and tie bars is achieved through a lubrication fitting 122 attached to the support pad, which transfers grease internally to external channels machined on the support pad at the surface of contact with the tie bars.

The support pin 116 can have multiple locations for the stopper 114, thus providing more than one operating position. This feature allows use of the mold support mechanism with various injection machines, having different distances between the tie bars 106. This mold support mechanism can also be attached onto manifold plates 6 (Y side) for central support.

The mold support mechanism 110 of this embodiment is designed for storage away from the Mold System. As part of the invention described above, the mold modules (defined above as comprising the cavity plate, core plate and respective inserts) can be removed from the injection machine separate from the entire Modular Mold Change System. Often it is desired to change the entire Modular Mold System from the mold machine. Below is described a procedure for removing the mold modules together with the entire Modular mold change system including all plates. When the system must be removed from the injection machine, the procedure to remove the mold support mechanism is as follows:
1. Injection machine closes mold.
2. Lifting bar 13 is attached at the top of the mold. Hoist is attached to lifting bar.
3. All Mold plates are unclamped from the machine platens (not shown). Machine platens open slowly for a short distance, so that complete mold system can be lifted slightly (to break contact with tie bars) without friction between the mold system and machine platens.
4. Fasteners 121 used to secure mold support mechanism bracket 118 to support pins 116 are removed. Support mechanisms are removed and stored safely away from the MMC. Stoppers 114 are removed, support pins are pushed in their respective pockets 111 in the mold plates, and stoppers 114 are re-installed to hold support pins in the storage position.
5. With support pins 116 retracted safely out of the way (as shown in FIG. 9C), the mold and mold change System are lifted, as one unit, out of the injection machine, and transported to desired storage location.

To install a mold system, the same procedure, in reversed order, may be used when necessary.

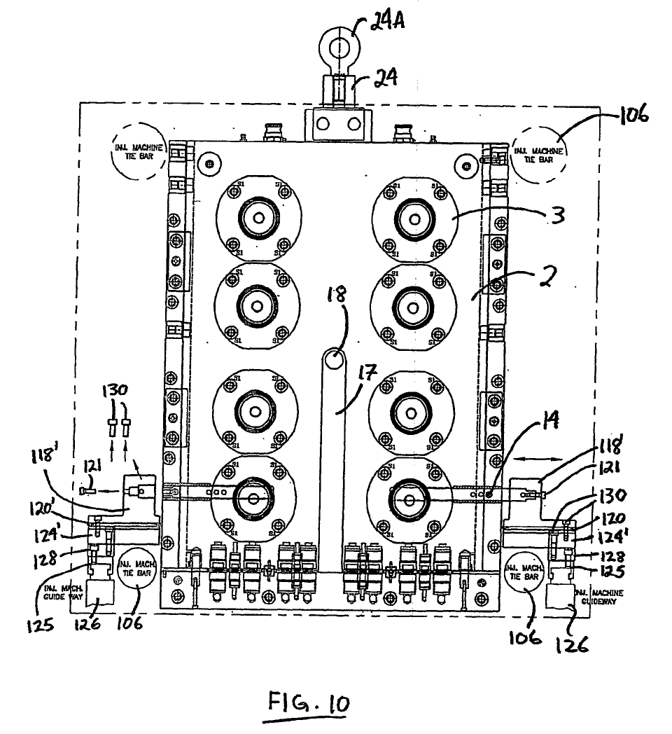

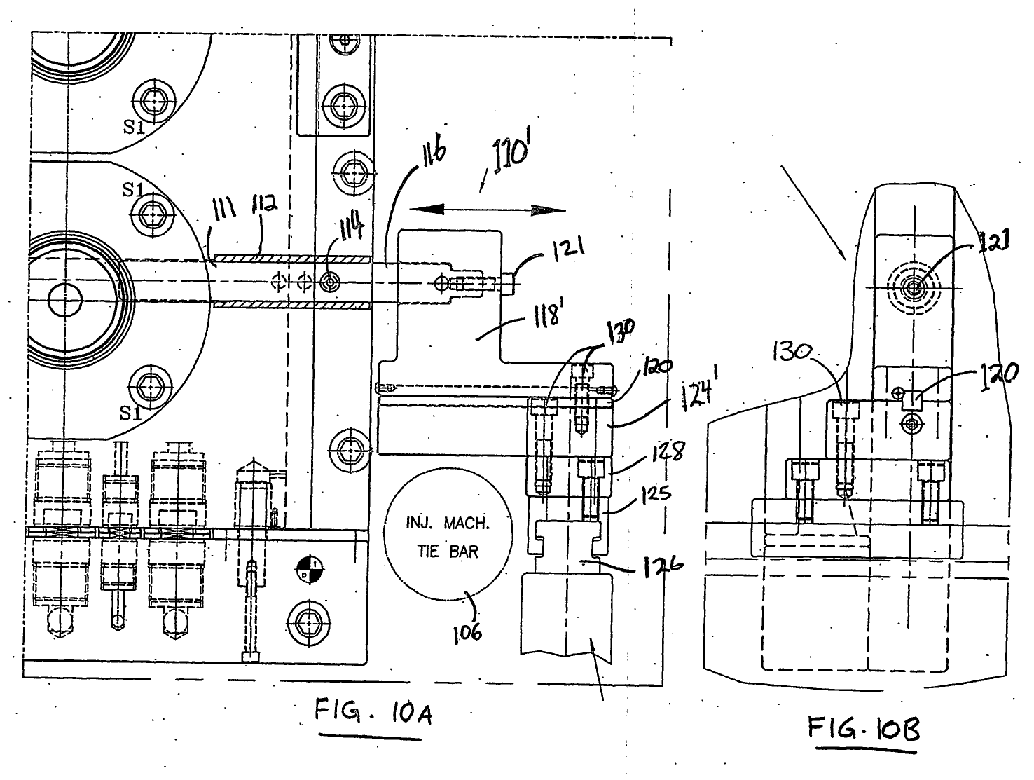

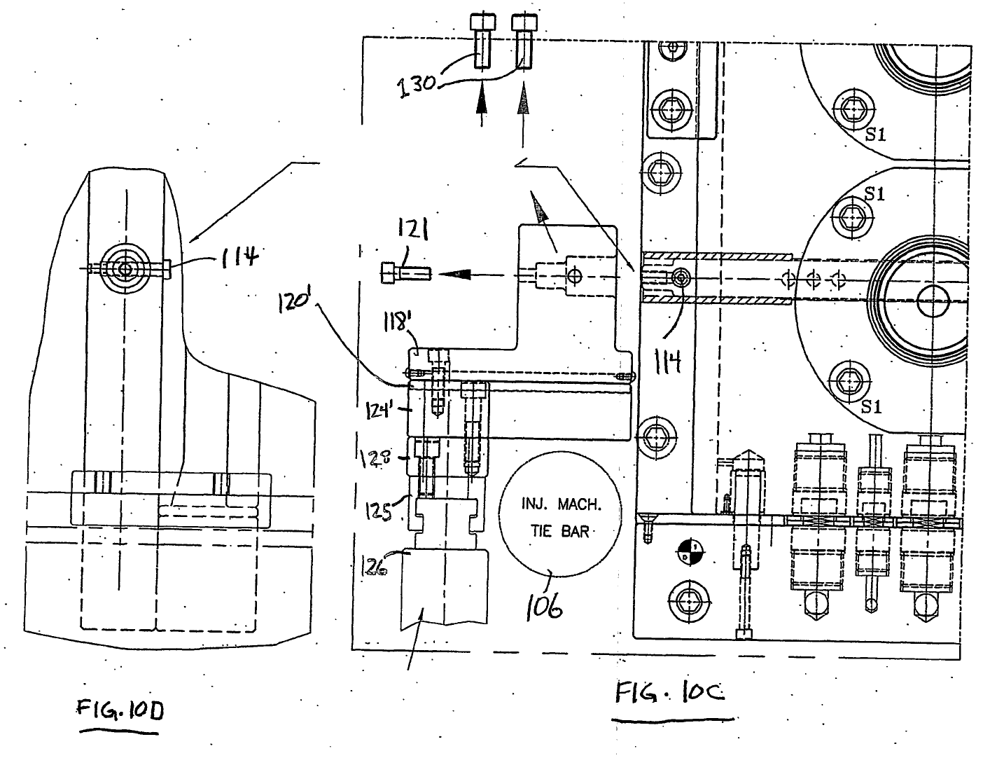

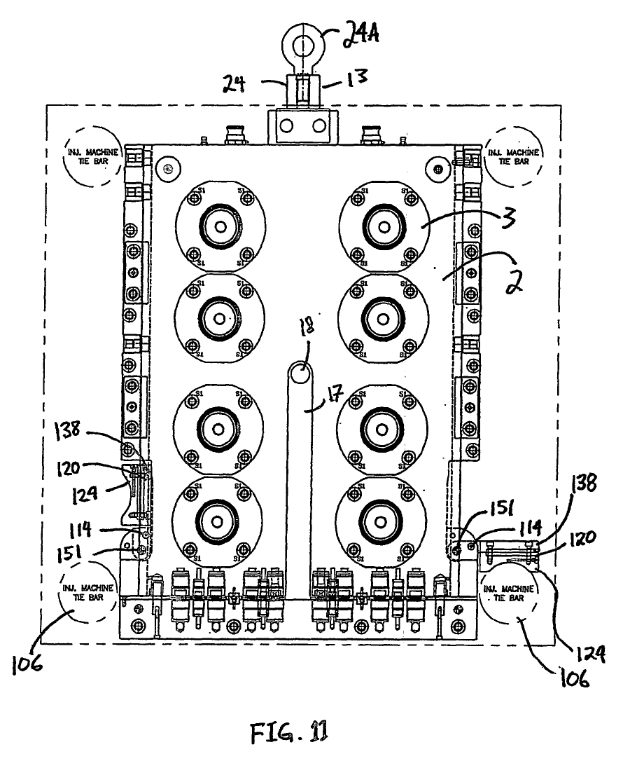

FIGS. 10 to 10D show a variation of the mold support mechanism of FIGS. 9 to 9D, that can be used with the guide ways 126 of the injection machine instead of the tie bars 106. This mold support mechanism can be attached to mold plates such as plates 1, 2, 5, 6 on both X and Y sides of the mold. In this embodiment, the mold plates are provided with pockets 111 shaped to accept support pins 116 and guide bushings 112. Each support pin 116 has one storage position shown in FIGS. 10C and 10D and multiple operating positions, to allow use of the mold support system in various injection machines, similar to the design of FIGS. 9 to 9D. The mold support system of this embodiment consists of the following components: a bracket 118′, similar to the one of FIGS. 9 to 9D, secured to the extended support pin 116, a support pad 124′, secured on one side to the bracket 118′, and on another side to a support block 128, which is in turn secured to a guide way rider 125. The guide way rider 125, as the name suggests, can ride on the machine guide ways (for moving plates), or can be secured in a fixed position on the machine guide ways (for stationary plates). Similar to the design of FIG. 9 to 9D, a locating key 120′ locates the support pad 124′ in reference to the bracket 118′. It should be noted that various support blocks and/or spacers may be used in any combination feasible to achieve desired spacing to the machine guide ways.

The mold support system of FIGS. 10A to 10D may be stored away from the mold. The procedure to remove this mold support system is similar to the one of FIGS. 9 to 9D:

The mold support system of the design of FIGS. 10 to 10D is an option for situations where the tie bars are in a less accessible position in reference to the mold plates. It should be understood that any of the designs of prior art, and also those which will be described in the following details, can be adapted for use with machine guide ways as described herein.

FIG. 11 shows another alternate mold support mechanism that can be attached to mold plates, on both X and Y sides of mold. In this embodiment, the mold support mechanism is permanently attached to a mold plate, and can pivot around a pivot point 151 of such plate, to reach the operating or the storage positions. It consists of three main parts: a bracket 138, having an extension connected to the mold plate, a support pad 124, and a locating key 120. The support pad and locating key are similar to the ones described in FIGS. 9 to 9D. The bracket 138 however is different, in that it is permanently attached to the mold plate (meaning that it is stored onto this plate when the mold system is to be removed from the injection machine), and in that it has a pivoting motion (while the brackets 118 of FIGS. 9 and 10 had a linear motion, as allowed by the sliding support pin 116). A stopper 114 is used to hold the bracket in one of the two generic positions, and to prevent it from accidentally rotating out of its required position.

The procedure to bring the mold support mechanisms to the storage position, for removal of the mold modules together with the Modular Mold Change System from the injection machine, is as follows:
1. Injection machine closes mold.
2. Lifting bar assembly 13 is attached at the top of the mold. Hoist is attached to lifting bar.
3. Mold plates are unclamped from the machine platens (not shown). Machine platens open slowly for a short distance, so that complete system can be lifted slightly (to break contact with tie bars) without friction between the system plates and machine platens.
4. Stoppers 114 holding the mold support mechanisms in the operating position are removed. The mold support mechanisms are rotated into the storage position (shown in FIG. 11). Stoppers 114 are installed to safely hold them in the storage position.
5. With mold support mechanisms rotated safely out of the way as shown on the left side of FIG. 11, the mold modules and Mold Change System are lifted, as one unit, out of the injection machine, and transported to desired storage location.

The same procedure, in reversed order, may be used to install the Modular Mold Change System in the injection machine when necessary. The mold modules can also be removed from the injection machine separately from the system following the procedure described above pertaining to the removal of mold modules.

One advantage of the support mechanism of FIG. 11 is that being part of a mold plate, it can be stored with the mold/MMC, thus not requiring additional storage space.

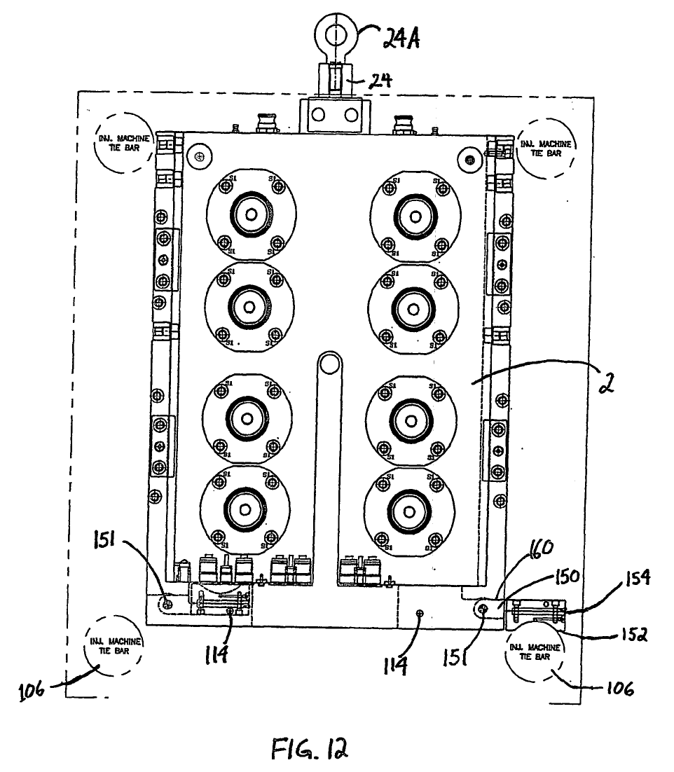

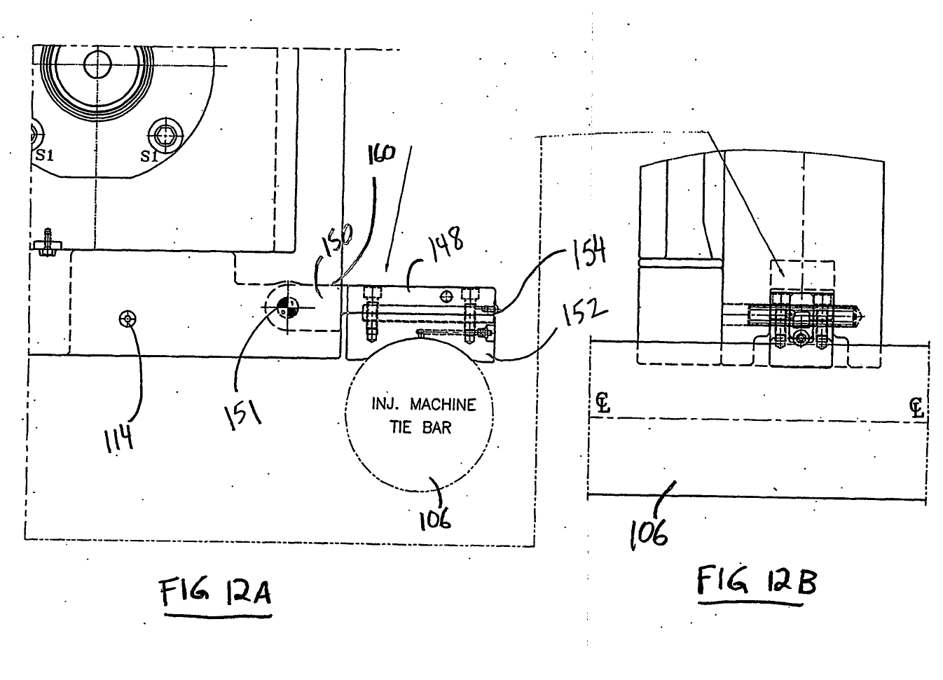

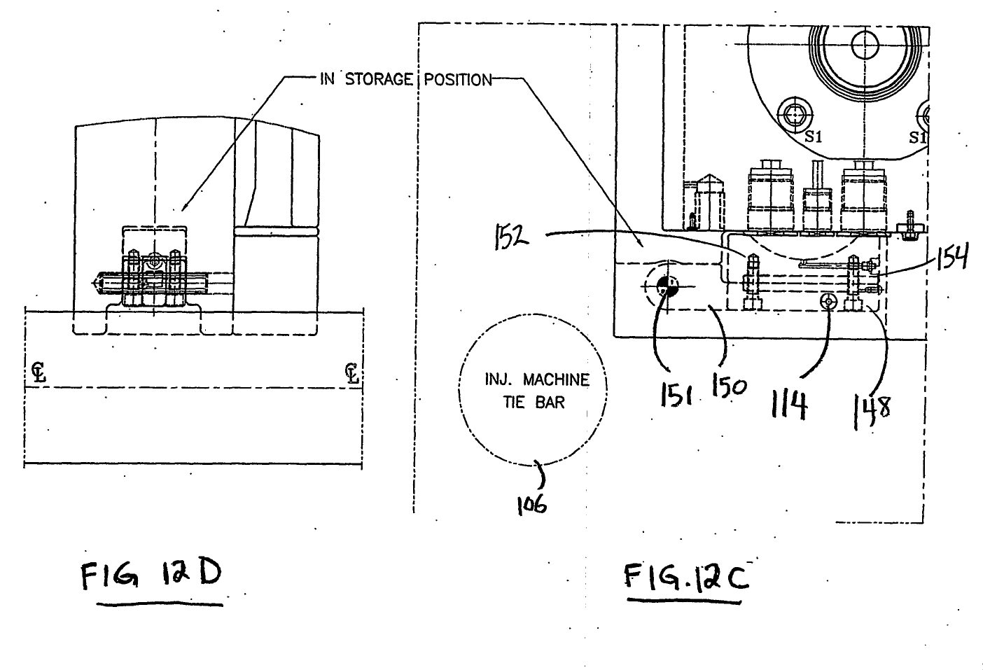

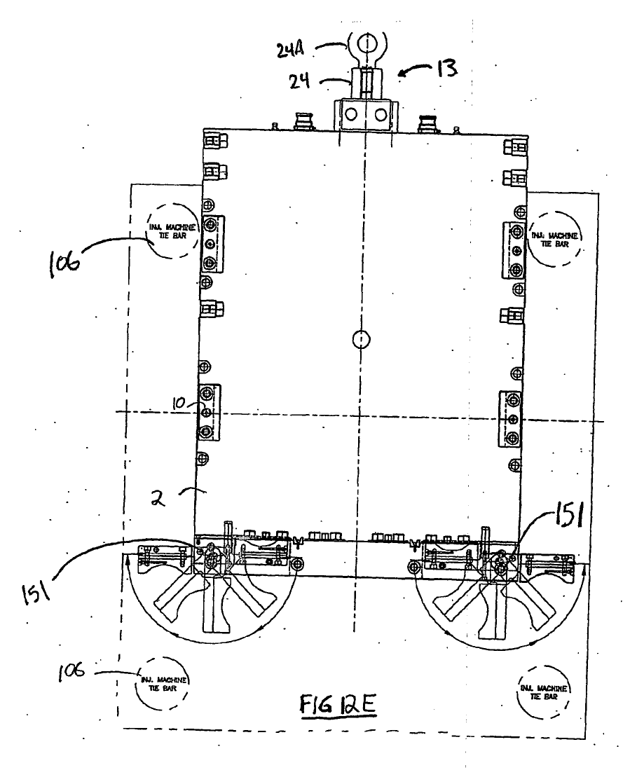

FIGS. 12, 12A, 12B, 12C, 12D, 12E show yet another alternate mold support mechanism, which is permanently attached to the mold plate, and which can pivot around a fixed point of such plate, to reach the operating or the storage positions. It consists of three main parts: a bracket 148, having an extension 150 connected to the mold plate at a pivot point 151, a support pad 152, and a locating key 154. The support pad and locating key are similar to the ones described in FIGS. 9 to 9D and 10 to 10D. The bracket 148 is similar to the one described in FIG. 11, in that it is permanently attached to the mold plate (meaning that it is stored onto this plate when the system MMC is to be removed from the injection machine), and in that it has a pivoting motion between the operating and the storage positions. When in operating position, the bracket 148 is backed by a surface 160 of the pocket in the mold plate 2, which prevents it from folding over under the combined forces of the mold weight and tie bar pressure (or guide way pressure, if used with machine guide ways). When in storage position in matching pocket at the bottom of the mold plate, a stopper 114 is used to hold the bracket in this position, and to prevent it from pivoting out under the gravitational pull as is shown in FIG. 12C.

The procedure to bring the mold support mechanisms to the storage position, for removal of the mold modules together with the Modular Mold Change System from the injection machine, is as follows (similar to that of FIG. 11):
1. Injection machine closes mold.
2. Lifting bar is attached at the top of the mold. Hoist is attached to lifting bar.
3. Mold plates are unclamped from the machine platens. Machine platens open slowly for a short distance, so that complete MMC can be lifted slightly (to break contact with tie bars) without friction between the MMC plates and machine platens.
4. As the MMC is lifted slowly, the mold support mechanisms rotate under the gravitational pull until completely free of the tie bars (or guide ways). The stoppers are removed, the mold support mechanisms are then brought in their pockets at the bottom of the mold plate, and stoppers are re-installed to hold the mold supports in storage position.
5. With mold support mechanisms rotated safely out of the way (shown in FIG. 12C), the mold and the Modular Mold Change System are lifted, as one unit, out of the injection machine, and transported to desired storage location.

The same procedure, in reversed order, is used to install the Modular Mold Change System in the injection machine when necessary. The mold modules can also be removed from the injection machine separately from the MMC, following the procedure described above pertaining to removal of mold module in our original application. FIG. 12E show the pivoting motion of the mold support systems as they are removed from the storage position and brought into the operating position. It is evident from FIG. 12E that mold supports must be brought to operating position well before reaching the range of the tie bars (or guide ways), and held in that position until resting firmly on the tie bars (or guide ways). Preferably stoppers may be used to hold the mold support while lowering the mold onto tie bars. One advantage of this support mechanism is that being part of a mold plate, it can be stored with the mold/MMC, thus not requiring additional storage space. It should be understood that the mold support mechanism of FIGS. 12 to 12E must be rotated to operating position when the MMC is still at a safe distance above the tie bars, to avoid interference between the swinging mold supports and the machine tie bars.

When mold modules (defined above as formed of cavity and core plates and respective inserts during the modular mold change process) are lowered for installation into the Modular Mold Change System (already clamped in the injection machine), the mold core plate 2 comes to rest somewhat loosely onto the water manifold 7 attached to the master core plate 1 of the Modular Mold Change System. Some tightening means are necessary in order to safely pull the mold core plate into firm contact with water manifold, and to accurately center the mold core plate to the master core plate, both horizontally and vertically, by way of the key blocks 20. The design shown in FIG. 13 represents an embodiment of such a system, in the form of a hooked handle.

When reinserting a mold module into the injection mold machine, to ensure the plates and conduits for air and cooling are attached properly, a final tightening of the modules in place is desired by having a tightening means attached to a fixed portion of the mold machine, and engaging a point on the mold modules. An example is shown in FIG. 13. The example shown in FIG. 13 illustrates a tightening system consisting of hooked handles 100, attached onto the surface of water manifold 7 which faces the cavity side, and of pins 102 installed onto the face of the mold core plate 2, right above the hooked handles. As the mold is lowered into the injection machine, the handle is in its “release” position (as shown on the left side of FIG. 13). When the mold core plate 2 comes to a stop resting onto the water manifold 7, the handles 100 are rotated to the “holding” position, shown on the right side of FIG. 13, where the hook extending from each handle grips the matching pin of the core plate, pulling the core plate firmly against the water manifold. A means of securing the handle in the two standard positions may be used.

It should be understood that such tightening/securing means can be located anywhere on the mold and MMC, not only on the front at bottom as shown, but also on the top or sides of the mold and the MMC. Also, any means designed to secure the mold plate firmly onto the water manifold of the MMC could be used as tightening system without departing from the scope of this embodiment of the invention.

In accordance with another aspect of the invention, typically, for single face molds having reversed gating, the core side is attached to the stationary machine platen (injection side), while the cavity side is attached to the moving machine platen (ejection side). For stack molds having reversed gating, the core plates 2 are attached to the manifold plates/hot runner system 6 of the MMC, while the cavity plates 5 are attached to the master core plates 1 of the MMC, which are clamped to the machine platens (not shown). Regardless of whether a mold is single face or stack type, for reversed gating cases the core side (which typically holds the ejection system of the mold) is not attached to the ejection side of the machine, therefore the mechanical means of ejection provided by the injection machine (e.g. knockout rods) cannot be used to eject the molded parts. In such cases, some other means of activating the ejection systems of the mold must be devised. Two such systems are shown in the next embodiments.

FIGS. 14 to 14C show an embodiment of such activating means, designed for use with the ejection system of molds having reverse gating (injection from the core side). In this embodiment, ejection is achieved by use of activating cylinders 174 (e.g. hydraulic or other), secured onto the plates of the hot runner assembly 6 (manifold plates), and controlled through connections from these plates 6. H-shaped 170 connectors, slide into matching pockets in the ejector plates (stripper plates) 172, are secured to the pistons of the activating cylinders 174. The controlled motion of the pistons of the activating cylinders 174, synchronized with the mold cycles, is transferred, through the H-connectors 170, to the ejector plates 172 (see FIG. 14A) to eject the molded article 380 when the mold is open. It should be understood that any shape, size and type of cylinders and connectors could be used to achieve this motion, without departing from the scope of this invention.

The activating cylinders 174 may be part of the Modular Mold Change System (specifically, part of the manifold plates/hot runner assembly 6). As shown in FIG. 14C, if the mold modules (comprising core plate, cavity plate and inserts therebetween) are to be removed from the injection machine, separate from the MMC, the connectors 170 must be disengaged from the pistons of the activating cylinders 174, and be temporarily stored away from the mold. The mold modules can then be removed from the MMC (in the manner described above pertaining to removal of mold modules, and another mold can be brought in. With the new mold properly installed, the connectors will be re-attached to the pistons of the activating cylinders 174.

In order to accommodate clearance of activation cylinders from the mold modules in FIG. 14C lift bar assembly 13′ must be designed to permit sufficient opening of the MMC, so that not only nozzle tips 16, but also activating cylinders 174 are protected when mold modules are lifted from the injection machine.

As described above, for stack molds all the plates of the mold module and modular mold change system located between the stationary side of the injection machine and the central portion of the MMC must be slotted to clear the sprue bar 18, which extends from the stationary platen to the manifold of the hot runner system. Such slotted design was also shown on Details 9 to 13. FIG. 14B shows an additional aspect of this embodiment, in the form of a linking plate 181 connecting the bottom portions of the ejector plate 172 (as separated by the clearance slot 183 for the sprue bar 18). The slot 183 weakens the ejector plate 172, and whenever the ejector plate 172 is activated simultaneously on a number of points (as is the case with activating cylinders located along its periphery), such linking means, such as linking plate 181, must be used as reinforcement: This is in order to prevent any possible deflection of the stripper plate 172, which could cause damage to the MMC.

The linking plate 181 must be removed prior to lifting the mold module (with or without the MMC) out of the injection machine, to avoid damage to the sprue bar 18 and/or to the ejector plate 172.

As shown in FIGS. 15 to 15D for cases where the hot runner assembly 6 is not equipped with controls for the activating cylinders 174, or as an alternative, the activating cylinders can be secured directly onto the core plates 2, thus becoming part of the mold modules being stored in pockets 197 in the core plate. In such cases, the controls must be brought in externally, separate from the hot runner assembly, directly from the injection machine. The activating cylinders 174 are brought in or removed from the injection machine together with the mold modules. This design also uses a linking plate 181 to strengthen the ejector plate. With the exception of the mounting location and source of controls for the activating cylinders, this embodiment is similar, in all other aspects, to the one shown in FIGS. 14 to 14D.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A method of removing components of an injection mold machine, said machine comprising the following components: a core assembly including a master core plate, a core plate releasably secured to said master core plate, said master core plate including guide means for guiding said core plate relative to said master core plate; a core insert secured to said core plate; a cavity assembly comprising a manifold plate, a first cavity plate releasably secured to the manifold plate, said first cavity plate oriented in the opposing direction to the core plate, a cavity insert attached to the cavity plate, said cavity assembly moveable relative to the core assembly such that the cavity insert and core insert may be selectively mated together to define a cavity therebetween into which molten plastic may be injected from a molten plastic source, said cavity forming a shape of a desired article, said method comprising the steps of:
(a) moving the core assembly and cavity assembly into a closed position whereat the cavity insert and core insert are mated together;
(b) securing said core plate to said cavity plate, thereby forming a mold module;
(c) releasing the securing means which secures the cavity plate to the manifold plate;
(d) opening the mold from the closed position, until the first cavity plate disengages the manifold plate and all connections thereto,
(e) releasing the securing means which secures the core plate to the master core plate;
(f) lifting said mold module in a direction perpendicular to the direction of motion between said open and closed position, said module being guided in in said perpendicular direction by said guide means.

2. A method of removing components of a stack injection mold machine, said machine comprising: a stationary core assembly and an opposing facing moving core assembly each core assembly including a master core plate, and a core plate releasably secured to the master core plate, a first core insert secured to said core plate, an intermediate cavity assembly comprising two central manifold plates secured to each other, a pair of cavity plates releasably secured on either side of said manifold plates, each cavity plate having a cavity insert, said cavity assembly and moving core assembly movable by moving mold press means in such a manner that the core inserts and cavity inserts are separated by equal amounts on either side of the cavity assembly, and may be mated together simultaneously, the cavity and core inserts defining a cavity therebetween each, into which molten plastic may be injected from a molten plastic sourse, said cavities forming the shape of a desired article, the method comprising the following steps:
(a) moving the core assemblies and cavity assembly into a closed position whereat the mating cavity inserts and core inserts are mated together;
(b) securing the core plates to their respective mating cavity plates to form respective mold modules comprised of core plates, core inserts, cavity inserts and cavity plates;
(c) releasing the securing means which secures the cavity plates to the manifold plate;
(d) moving the moving core assembly and cavity assembly from the closed position to an open position until said cavity plates are separated from said manifold plate and all connections thereto;
(e) releasing said securing means which secures said core plates to said respective master core plates;
(f) hoisting said first and second mold modules simultaneously outwardly in a direction perpedicular to the direction of motion between said open and closed position, said modules being guided in said perpendicular direction by guiding means which guides said core plates perpendicularly along said master core plates.

3. The method as recited in claim 1, wherein said guide means comprises a set of roller guides secured to the master core plate and rollingly engaging said first core plate, said guide means following a guide path perpendicular to the motion of the mold machine, facilitating removal of said mold module from said mold machine.

4. The method as recited in claim 3 wherein said roller guides guide the core plate relative to said master core plate along a contoured slot defined in the master core plate, said slot being shaped to allow core plate to move vertically and parallel to master core plate for an initial period thereby causing disengagement of quick disconnect couplings between plates, then shaped to allow the core plate (and attached module) to move slightly away from the master core plate so that the mold module may be then be rapidly hoisted out of the mold machine.

5. The method as recited in claim 2 further comprising the step of applying an hoist attachment member simultaneously to the periphery of each said module when in closed position, said modules being slidably engaged to said hoist attachment, slidable in the direction of opening and closing the mold machine, such that when said modules are attached to the hoist attachment, they may be moved to the open position to allow said separation of cavity plates from said manifold plates and disengagement of quick disconnect couplings between plates, and once said modules are so separated and couplings disengaged, hoisting said hoist attachment.

6. The method as recited in claim 5 wherein said hoist attachment further includes a stop at opposite ends thereof, which limits the sliding movement of each block beyond the point where said cavity plates and components thereof are separated from said manifold plate and accommodates replacement modules with the same dimensions.

7. The method as recited in claim 1 comprising the further step of attaching hoisting means to each said mold module after said step (d) and prior to said step (e).

8. The method as recited in claims 1, wherein said mold machine defines water and air conduits extending between at least two adjacent plates, said conduits being selectively disengageable and reengageable by quick disconnect couplings during module removal and reattachment respectively.

9. The method as recited in claim 2 wherein mating locating keys are positioned to locate said modules for reattachment upon said mold machine.

10. The method as recited in claim 1 wherein said securing means securing said cavity plate to the manifold plate are releasable straps secured across the periphery of said cavity and manifold plates and said securing means securing each said core plate to said master core plates is clamp bar means.

11. A method of removing components of an injection mold machine, said machine comprising the following components: a core assembly including a master core plate, a cavity plate releasably secured to said master core plate, said master core plate including guide means for guiding said cavity plate relative to said master core plate; a cavity insert secured to said cavity plate, an intermediate assembly comprising manifold plates, a first core plate releasably secured to the manifold plate, said first core plate oriented in the opposing direction to the cavity plate, a core insert attached to the core plate, said intermediate assembly moveable relative to the core assembly such that the cavity insert and core insert may be selectively mated together to define a cavity therebetween into which molten plastic may be injected from a molten plastic source, said cavity forming a shape of a desired article, said method comprising the steps of:
(a) moving the core assembly and intermediate assembly into a closed position whereat the cavity insert and core insert are mated together;
(b) securing said core plate to said cavity plate, thereby forming a mold module;
(c) releasing the securing means which secures the core plate to the manifold plate;
(d) opening the mold from the closed position, until the first core plate disengages the manifold plate and all connections thereto,
(e) releasing the securing means which secures the cavity plate to the master core plate;
(f) lifting said mold module in a direction perpendicular to the direction of motion between said open and closed position, said module being guided in in said perpendicular direction by said guide means.

12. The method as recited in claim 11 further comprising the step of applying an hoist attachment member simultaneously to the periphery of each said module when in said closed position, said modules being slidably engaged to said hoist attachment, slidable in the direction of opening and closing the mold machine, such that when said modules are attached to the hoist attachment, they may be moved to the open position to allow said separation of core plates from said manifold plates and disengagement of quick disconnect couplings between plates, and once said modules are so separated and couplings disengaged, hoisting said hoist attachment.

13. A hoist bar, comprising a main bar having an upper side and a lower side, and a pair of blocks secured to the lower side of said bar at opposite ends thereof, each block having an opening parallel to the length of the bar, said bar having at least one hoist member secured to the upper side of the bar, said hoist member adapted for lifting said bar, a guide pin extending through the opening in each said block, said guide pins having mounting blocks at the end of each guide pin, which limit the sliding movement of the guide pins within each opening, each said mounting block being adapted to mount a mold plate, thereby when said mounting blocks are mounted to said plates, said plates may slide relative to the main bar, and said hoist bar may be lifted when said mounted mold plates have slid into a selectable relative sliding position on the lift bar.

14. (canceled)

15. The method as recited in claim 2 wherein a mold support apparatus supports the mold plates within said mold machine, said apparatus comprising mold support pieces interconnecting said plates to said machine, each said support piece engaged to one said plate and the tie bars or guide ways of said machine, each said support pieces positionable between an operable position wherein each interconnects said plate to said tie bars or guide ways and an inoperable position, wherein said support piece nests within said mold plate.

16. An apparatus for removing components of an injection mold machine, said machine comprising the following components: a core assembly including a master core plate, a core plate releasably secured to said master core plate, said master core plate including guide means for guiding said core plate for movement relative to said master core plate; said core plate including a core insert secured to said core plate, the core insert having a front face;
a cavity assembly comprising a manifold plate, a first cavity plate releasably secured to the manifold plate, said first cavity plate oriented in the opposing direction to the core plate, a cavity insert attached to the cavity plate, said cavity assembly moveable relative to the core assembly between open and closed positions such that in the closed position, the cavity insert and core insert may be selectively mated together to define a cavity therebetween into which molten plastic may be injected from a molten plastic source, said cavity forming a shape of a desired article in said closed position, the core plate may be secured to said cavity plate to form a mold module, whereby when said cavity plate is released from securement to the manifold plate and all connections therebetween are disengaged and the core plate is released from securement to the master core plate and all connections therebetween are disengaged, the mold module may be lifted in a direction perpendicular to the direction of motion between said open and closed position, said module being guided in said perpendicular direction by said guide means.

17. An apparatus for removing components of a stack injection mold machine, comprising: a stationary core assembly and an opposing facing moving core assembly each core assembly including a master core plate, and a core plate releasably secured to the master core plate, said core plate having a face, a first core insert secured to said core plate face, an intermediate cavity assembly comprising central manifold plates having opposing sides, one side facing the stationary core assembly the other side facing the moving core assembly, one cavity plate releasably secured to each said opposing side of the manifold plates, each cavity plate having a cavity insert secured thereto, one cavity plate and insert facing the core plate and insert of stationary core assembly to form one cavity core insert pair, and the other cavity plate and insert facing the core plate and core insert of the moving core assembly to form another cavity core insert pair, said cavity assembly and moving core assembly movable by moving mold press means in such a manner that the cavity and core insert of each pair are separated by equal amounts on either side of the cavity assembly, and in a closed position, the cavity and core inserts of each pair are be mated together simultaneously defining a cavity between the inserts of each pair, into which molten plastic may be injected from a molten plastic source, said cavities forming the shape of a desired article, and in said closed position, the core plate and cavity plate of each pair may be secured together to form respective mold modules each comprised of a core plate, core inserts, cavity insert and cavity plate; once said cavity plates are released from securement to the manifold plates and all connections therebetween disengaged, the moving core assembly and cavity assembly may be moved from the closed position to an open position where said cavity plates become separated from said manifold plates; and once said core plates are released from securement to said respective master core plates and all connections therebetween are disengaged, said first and second mold modules may be simultaneously hoisted outwardly in a direction perpendicular to the direction of motion between said open and closed position, said modules being guided in said perpendicular direction by guiding means which guides said core plates perpendicularly along said master core plates.

18. The apparatus as recited in claim 16, wherein said guide means comprises a set of roller guides secured to the master core plate and rollingly engaging said first core plate, said guide means forming a guide path perpendicular to the motion of the mold machine, facilitating removal of each said mold module from said mold machine.

19. The apparatus as recited in claim 18 wherein said roller guides guide the core plate relative to said master core plate along a countoured slot defined in the master core plate, said slot being shaped to allow core plate to move vertically and parallel to master core plate for an initial distance thereby causing disengagement of quick disconnect couplings between plates, then spaced away from the master core plate for a further distance so as to accommodate the mold module from being rapidly hoisted out of the mold machine.

20. The apparatus as recited in claim 16 wherein the position of said cavity plates and core plates are interchanged.

21. The apparatus as recited in claim 17 further comprising a hoist attachment member secured simultaneously to the periphery of each said module when in said closed position, said modules being slidably engaged to said hoist attachment, slidable in the direction of opening and closing the mold machine, such that when said modules are attached to the hoist attachment, each said module may be moved to the open position from said closed position to allow said separation of the cavity plates of each module from the manifold plates, and once said cavity plates are so separated, and said core plates released from securement to said master core plates, said mold modules may be hoisted out of said mold machine.

22. The apparatus as recited in claim 21 wherein said hoist attachment further includes a stop at opposite ends thereof, which limits the sliding movement of each block beyond the point where said cavity plates and components thereof are separated from said manifold plate.

23. The apparatus as recited in claim 16 wherein said machine further comprises an ejector plate operable to assist in ejection of the molded article from within said cavity, said ejector plate defining a slot therethrough extending from a central portion of said plate to a peripheral portion of the plate, said plate having a linking plate secured across said slot at said peripheral portion to reinforce said plate across said slot.

24. The apparatus as recited in claim 21 wherein said hoist attachment comprises a main bar having an upper side and a lower side, and a pair of blocks secured to the lower side of said bar at opposite ends thereof, each block having an opening parallel to the length of the bar, said bar having at least one hoist member secured to the upper side of the bar, said hoist member adapted for lifting said bar, a guide pin extending through the opening in each said block, said guide pins having mounting blocks at the end of each guide pin, which limit the sliding movement of the guide pins within each opening, one said mounting block being adapted to mount a core mold plate and the other a cavity plate of each said mold module, such that when said mounting blocks are mounted to said plates, said plates may slide relative to the main bar, and said hoist bar may be lifted when said mounted mold plates are positioned in said open position.

25. The apparatus as recited in claim 24 wherein said at least one hoist member comprises a eye bolt secured to the upper side of the bar.

26. The apparatus as recited in claim 25 wherein one said eye bolt is positioned at the center of the bar.

27. The apparatus as recited in claim 25 wherein one said eye bolt is positioned at each opposite end of the bar.

28. The apparatus as recited in claim 16 wherein said core plates may be secured to the cavity plate to form said mold module by safety straps secured between the periphery of each said core plate and cavity plate and said cavity plates are releasably secured to said manifold plates by removable straps and said core plates are releasably secured to said master core plates by clamp bar means.

29. (canceled)

30. (canceled)

31. An apparatus for supporting mold plates within a mold machine, said apparatus comprising: a mold support member, said support member being positionable between an operable position whereat said support member interconnects by interconnection means said plates to a tie bar or guide way of the mold machine, allowing riding of said plate on said tie bar or guide way and an inoperable position whereat said interconnection means nests within a pocket in said plate.

32. An apparatus as recited in claim 31 wherein said interconnection means comprises support pins, and said mold plate includes a pocket shaped to accept said support pins which are moveable within said pocket between an extended position where they stick out towards said tie bars and hold the support member in the operable position, and a retracted position where they are nested in the pockets of the mold plates, in the inoperable position, said support pins being guided by bushings held in fixed position in mold plates, a stopper being used to secure each support pin in one of the positions, and to prevent it from disengaging from the mold plate.

33. The apparatus as recited in claim 32 wherein said mold support apparatus includes, a bracket portion, a support pad and a locating key, the bracket portion being secured to the pin, the bracket portion being fastened to the support pad which has a surface shaped to rest onto the tie bars of the injection machine, said locating key locating the support pad in reference to the bracket portion.

34. The apparatus as recited in claim 33 wherein the support pad is made of a material with low coefficient of friction, in order to avoid scoring the tie bars of the injection machine.

35. The apparatus as recited in claim 33 wherein said support pin has multiple locations for the stopper, thus providing more than one operating position and said size variability.

36. The apparatus as recited in claim 33 which is adapted to ride on machine guide ways.

37. The apparatus as recited in claim 31 wherein the mold support member is permanently attached to one said mold plate, pivotable around a pivot point on said plate between said operable position and said inoperable position, when in said inoperable position said member is positioned within a pocket defined in said plate.

38. (canceled)

39. (canceled)

40. The apparatus as recited in claim 33 wherein said bracket portion may be adjustable in size to accommodate various spacings of said tie bars and guide ways.

41. The apparatus as recited in claim 28 wherein the clamp bar means includes at least one clamp bar securing the plates together with screwable fasteners, the at least one clamp bar including a pre loaded spring under the clamp which provides lift to open the clamp as the screwable fasteners are unscrewed.

42. The apparatus as recited in claim 41 wherein each said at least one clamp bar is secured using two spaced apart bolts.

43. The apparatus as recited in claim 42 wherein said master core plate utilizes between 4 and 6 said clamp bars.
